(19) United States
(12) Patent Application Publication
(10) Pub. No.: US 2009/0274940 A1
(43) Pub. Date: Nov. 5, 2009

(54) FUEL CELL AND FUEL CELL SYSTEM

(76) Inventors: Junji Morita, Kyoto (JP); Yasushi Sugawara, Osaka (JP); Takayuki Urata, Hyogo (JP); Takahiro Umeda, Nara (JP); Shinsuke Takeguchi, Osaka (JP)

Correspondence Address: MCDERMOTT WILL & EMERY LLP, 600 13TH STREET, NW, WASHINGTON, DC, 20005-3096, US

(21) Appl. No.: 12/375,460

(22) PCT Filed: Jul. 27, 2007
(86) PCT No.: PCT/JP2007/064766

§ 371 Date: Jan. 28, 2009

(30) Foreign Application Priority Data
Jul. 28, 2006 (JP) 2006-206530

(51) Int. Cl. H01M 8/04

(52) U.S. Cl. 429/24; 429/26; 429/22

(57) ABSTRACT

A fuel cell (101) of the present invention includes: a stack (1) formed such that one or more reacting portions (P) which generate electric power and heat by a reaction of a reactant gas and one or more heat transferring portions (H) which exchange heat with the reacting portions (P) by flow of a heat medium are arranged adjacent to each other in a stack direction of cells (2) by stacking the cells (2); a first heat medium supply manifold (8A) through which the heat medium is supplied to the heat transferring portions formed at both end portions (E) of the stack in the stack direction; a second heat medium supply manifold (8B) through which the heat medium is supplied to the heat transferring portions formed at a remaining portion (R) of the stack which portion is a portion other than the end portions of the stack; and a heat medium discharge manifold (9) through which the heat medium is discharged from the heat transferring portions.

### TECHNICAL FIELD

The present invention relates to a fuel cell which generates electric power using a fuel gas and an oxidizing gas, and a fuel cell system using the fuel cell.

### BACKGROUND ART

Known as a typical fuel cell is a polymer electrolyte fuel cell. Generally, the polymer electrolyte fuel cell is configured by stacking cells, each of which includes a polymer electrolyte membrane, and an anode and a cathode sandwiching the polymer electrolyte membrane.

The polymer electrolyte fuel cell configured by stacking the cells include a fuel gas supply manifold, a fuel gas discharge manifold, an oxidizing gas supply manifold, an oxidizing gas discharge manifold, a heat medium supply manifold, and a heat medium discharge manifold. The polymer electrolyte fuel cell generates electric power and heat by a reaction between a fuel gas supplied through the fuel gas supply manifold to an anode of each cell and an oxidizing gas supplied through the oxidizing gas supply manifold to a cathode of each cell. To recover this heat, a heat medium is supplied through the heat medium supply manifold to a heat medium channel formed at an appropriate position of the polymer electrolyte fuel cell, and the supplied heat medium is discharged through the heat medium discharge manifold.

Typically used as the heat medium is water or silicone oil. The heat medium is supplied through the heat medium supply manifold to respective cells at the time of the start-up of the fuel cell system. In addition, the heat medium functions to supply its heat to the fuel cell at the time of the start-up to increase the temperature of the fuel cell.

In the case of using the fuel cell system as a domestic cogeneration system, a city gas containing, for example, methane as a major component is used as a raw material of the fuel gas. In this case, to reduce heat and electricity costs, an operating method (DSS (Daily Start-up & Shut-down) operation) for stopping the fuel cell system in a time period (midnight) in which electricity consumption is small and causing the fuel cell system to generate the electric power in a time period (daytime) in which the electricity consumption is large is effective. Since the electric power generation and stopping of the fuel cell system are repeated in the DSS operation, it is desirable that the fuel cell system can flexibly deal with an operation pattern including the electric power generation and the stopping.

However, the operating method which repeats the electric power generation and the stopping has the problem that the cells located at both end portions of a stack decrease in temperature at the time of the start-up and the electric power generation of the fuel cell system.

To be specific, in accordance with conventional fuel cell systems, since the fuel cell release heat from end plates of both end portions of the stack, the cells in the vicinity of the end plates are lower in temperature than the other cells. Therefore, at the time of the start-up and the eclectic power generation, electric power generating performances of the cells in the vicinity of the end plates of the stack are lower than those of the other cells.

Here, disclosed is a fuel cell stack which does not include cooling medium channels of an anode separator and a cathode separator which are located on both ends, respectively, of the cell in a stack direction in which the cells are stacked, (see Patent Document 1). In such fuel cell stack, the cells located on both ends of the fuel cell stack in the stack direction are prevented from decreasing in temperature.

Moreover, disclosed is a fuel cell stack of a fuel cell system whose output when the fuel cell system is high in temperature is lower than that when the fuel cell system is low in temperature (see Patent Document 2). When warming up the fuel cell in this fuel cell stack, the heat medium is caused to circulate only a partial portion of each of all the cells through a bypass passage, and then circulate a remaining portion of each of all the cells through a main passage. In such fuel cell system, a predetermined output can be obtained in a short period of time when the fuel cell system starts up at low temperature.

Patent Document 1: Japanese Laid-Open Patent Application Publication 2002-216806

Patent Document 2: Japanese Laid-Open Patent Application Publication 2004-228038

### DISCLOSURE OF THE INVENTION

### Problems to be Solved by the Invention

However, the fuel cell stack described in Patent Documents 1 and 2 includes only one heat medium supply manifold, and the temperature of the stack is controlled only at the time of the start-up or the electric power generation.

The present invention was made to solve the above problems, and an object of the present invention is to provide a fuel cell and a fuel cell system, each of which controls the temperature of the stack at the time of both the start-up and the electric power generation.

### Means for Solving the Problems

As a result of diligent studies, the present inventors have found the followings.

To increase the temperature of the fuel cell, the heat medium is caused to circulate at the time of the start-up of the fuel cell. In this case, since the heat is released from the end plates of both end portions of the stack, the temperature of the fuel cell does not increase so much, so that it is more necessary to heat the end portions of the stack by the heat medium. At the same time, since the amount of heat released from a portion (remaining portion) other than both end portions of the stack is small, it is less necessary to heat the remaining portion by the heat medium as compared to both end portions of the stack.

In contrast, since the fuel cell generates reaction heat by an electric power generating reaction between the fuel gas and the oxidizing gas at the time of the electric power generation of the fuel cell, the heat medium is caused to circulate to cool down the fuel cell. Since both end portions of the stack becomes a suitable temperature by the heat generated by the electric power generating reaction between the fuel gas and the oxidizing gas and the heat release from the end plates, it is less necessary to cool down the end portions of the stack. At the same time, since the heat generated by the electric power generating reaction is larger than the heat release from the remaining portion of the stack, it is more necessary to cool down the remaining portion by the heat medium.

In order to solve the above problems, a fuel cell of the present invention includes: a stack formed such that one or more reacting portions which generate electric power and heat by a reaction of a reactant gas and one or more heat transferring portions which exchange heat with the reacting portions by flow of a heat medium are arranged adjacent to each other in a stack direction of cells by stacking the cells; a first heat medium supply manifold through which the heat medium is supplied to the heat transferring portions formed at both end portions of the stack in the stack direction; a second heat medium supply manifold through which the heat medium is supplied to the heat transferring portions formed at a remaining portion of the stack which portion is a portion other than the end portions of the stack; and a heat medium discharge manifold through which the heat medium is discharged from the heat transferring portions.

With this configuration, the heat medium can be separately supplied through two heat medium supply manifold to the heat transferring portions formed at both end portions of the stack and the heat transferring portions formed at the remaining portion of the stack. To be specific, at the time of the start-up of the fuel cell, the heat medium heated is supplied through the first heat medium supply manifold to the heat transferring portions of the end portions of the stack to quickly increase the temperatures of the heat transferring portions of the end portions of the stack. Meanwhile, at the time of the electric power generation of the fuel cell, the heat medium is supplied to the heat transferring portions of the remaining portion of the stack to decrease the temperature of the remaining portion of the stack, and the amount of heat medium supplied to the heat transferring portions of both end portions of the stack is controlled to suppress the temperature decrease of the end portions of the stack. Therefore, it is possible to control the temperature of the stack at the time of both the start-up of the fuel cell and the electric power generation of the fuel cell.

The first heat medium supply manifold, the second heat medium supply manifold, and the heat medium discharge manifold may be formed inside the stack so as to extend in the stack direction of the cells.

The first heat medium supply manifold may be formed over an entire length of the stack.

The first heat medium supply manifold may be formed only at each of the both end portions.

The fuel cell of the present invention may further include: a first flow rate increasing/limiting device configured to increase and limit the flow of the heat medium from an outside to the first heat medium supply manifold by increasing and decreasing an opening degree thereof, and a second flow rate increasing/limiting device configured to increase and limit the flow of the heat medium from the outside to the second heat medium supply manifold by increasing and decreasing an opening degree thereof.

With this configuration, by increasing and decreasing the opening degrees of the first flow rate increasing/limiting device and the second flow rate increasing/limiting device to increase and limit the flow of the heat medium to the first heat medium supply manifold and the second heat medium supply manifold, it is possible to select which manifold the heat medium flows through, and change the flow rate of the heat medium in the first heat medium supply manifold and the flow rate of the heat medium in the second heat medium supply manifold.

In the fuel cell of the present invention, the heat medium discharge manifold may include at least a first heat medium discharge sub-manifold and a second heat medium discharge sub-manifold, the heat medium in the heat transferring portions of the both end portions may be discharged through the first heat medium discharge sub-manifold, and the heat medium in the heat transferring portions of the remaining portion may be discharged through the second heat medium discharge sub-manifold.

With this configuration, it is possible to separately form a heat medium flow passage extending to the heat transferring portions of both end portions of the stack and a heat medium flow passage extending to the heat transferring portions of the remaining portion of the stack. As a result, the heat medium supplied to the heat medium flow passage extending to the heat transferring portions of both end portions of the stack and the heat medium supplied to the heat medium flow passage extending to the heat transferring portions of the remaining portion of the stack can be made different in temperature from each other.

A first fuel cell system of the present invention includes: the fuel cell having the first heat medium supply manifold and the second heat medium supply manifold; a reactant gas supplying device configured to supply the reactant gas to the fuel cell; a heat medium supplying device configured to supply the heat medium to the first heat medium supply manifold and the second heat medium supply manifold; and a controller.

Moreover, a second fuel cell system of the present invention includes: the fuel cell having the first heat medium supply manifold, the second heat medium supply manifold, the first flow rate increasing/limiting device, and the second flow rate increasing/limiting device; a reactant gas supplying device configured to supply the reactant gas to the fuel cell; a heat medium supplying device configured to supply the heat medium through the first flow rate increasing/limiting device to the first heat medium supply manifold and through the second flow rate increasing/limiting device to the second heat medium supply manifold; a temperature detector configured to directly or indirectly detect the temperature of the heat medium flowing through the heat medium discharge manifold or the temperature of the heat medium discharged from the heat medium discharge manifold; and a controller configured to control the opening degree of the first flow rate increasing/limiting device and the opening degree of the second flow rate increasing/limiting device.

The second fuel cell system of the present invention may include: an external heat medium flow passage through which the heat medium discharged from the heat medium discharge manifold returns to the heat medium supplying device; a bypass passage connecting a portion of the external heat medium flow passage to the heat medium supplying device; a heat exchanger disposed on a portion (hereinafter referred to as “bypassed portion”) of the external heat medium flow passage which portion is bypassed by the bypass passage, and configured to exchange heat with the heat medium flowing through the bypassed portion; and a flow rate adjuster disposed on the bypassed portion of the external heat medium flow passage and configured to be controlled by the controller so as to adjust the flow rate of the heat medium flowing through the bypassed portion.

In the second fuel cell system of the present invention, the controller may be configured to cause the flow rate controller to change a mixing ratio between the heat medium having flowed through the bypassed portion of the external heat medium flow passage and the heat medium having flowed through the bypass passage of the external heat medium flow passage, which are mixed in the heat medium supplying device, to control the temperature of the heat medium supplied from the heat medium supplying device.

In the second fuel cell system of the present invention, the controller may be configured to control the opening degree of the first flow rate increasing/limiting device and the opening degree of the second flow rate increasing/limiting device based on the temperature of the heat medium detected by the temperature detector.

With this configuration, in accordance with the temperature of the heat medium discharged from the heat medium discharge manifold, it is possible to allow and inhibit the flow of the heat medium to the first heat medium supply manifold and/or the second heat medium supply manifold, and change the flow rate of the heat medium to the first heat medium supply manifold and/or the second heat medium supply manifold.

The second fuel cell system of the present invention may further include an electric power circuit portion configured to take out the electric power from the fuel cell, wherein: the controller may cause the fuel cell to carry out an electric power generating mode in which the fuel cell generates the electric power and supplies the electric power to an external load and a start-up mode in which the fuel cell shifts from a stop state to the electric power generating mode; while the temperature of the heat medium detected by the temperature detector is lower than an electric power generation start temperature T₁ in the start-up mode, the controller may cause the first flow rate increasing/limiting device to increase the opening degree to supply the heat medium without limit through the first heat medium supply manifold to the heat transferring portions of the end portions, and cause the second flow rate increasing/limiting device to increase the opening degree to supply the heat medium without limit through the second heat medium supply manifold to the heat transferring portions of the remaining portion; when the temperature of the heat medium detected by the temperature detector is the electric power generation start temperature T₁ or higher, the controller may maintain the opening degree of the first flow rate increasing/limiting device and cause the second flow rate increasing/limiting device to decrease the opening degree to cause the reactant gas supplying device to supply the reactant gas to the fuel cell and cause the electric power circuit portion to take out the electric power; and when the temperature of the heat medium detected by the temperature detector is an electric power generation continuable temperature T₂ or higher which is higher than the electric power generation start temperature T₁, the controller may cause the first flow rate increasing/limiting device to decrease the opening degree to limit the flow of the heat medium to the heat transferring portions of the end portions and cause the second flow rate increasing/limiting device to increase the opening degree to supply the heat medium without limit to the heat transferring portions of the remaining portion, to cause the fuel cell system to shift to the electric power generating mode.

With this configuration, it is possible to control the temperature of the stack while changing the flow of the heat medium to the first heat medium supply manifold and the flow of the heat medium to the second heat medium supply manifold. Then, when the temperature of the entire stack is stabilized, the fuel cell can stably generate the electric power.

The first flow rate increasing/limiting device may be a first opening/closing device configured to open to allow the flow of the heat medium to the first heat medium supply manifold and close to inhibit the flow of the heat medium to the first heat medium supply manifold, the second flow rate increasing/limiting device may be a second opening/closing device configured to open to allow the flow of the heat medium to the second heat medium supply manifold and close to inhibit the flow of the heat medium to the second heat medium supply manifold, increasing the opening degrees of the first and second flow rate increasing/limiting devices to supply the heat medium without limit may be opening the first and second opening/closing devices to supply the heat medium, and decreasing the opening degrees of the first and second flow rate increasing/limiting devices to limit the flow of the heat medium may be closing the first and second opening/closing devices to stop the flow of the heat medium.

With this configuration, by opening and closing the first opening/closing device and the second opening/closing device to allow and inhibit the flow of the heat medium to the first heat medium supply manifold and the flow of the heat medium to the second heat medium supply manifold, it is possible to supply the heat medium to the first heat medium supply manifold and the second heat medium supply manifold and stop supplying the heat medium to the first heat medium supply manifold and the second heat medium supply manifold. Therefore, it is possible to select which of the first heat medium supply manifold and the second heat medium supply manifold the heat medium flows through.

The first flow rate increasing/limiting device may be a first flow rate adjuster configured to adjust the flow rate of the heat medium flowing to the first heat medium supply manifold, the second flow rate increasing/limiting device may be a second flow rate adjuster configured to adjust the flow rate of the heat medium flowing to the second heat medium supply manifold, increasing the opening degrees of the first and second flow rate increasing/limiting devices to supply the heat medium without limit may be increasing the opening degrees of the first and second flow rate adjusters to increase the flow rate of the heat medium, and decreasing the opening degrees of the first and second flow rate increasing/limiting devices to limit the flow of the heat medium may be decreasing the opening degrees of the first and second flow rate adjusters to decrease the flow rate of the heat medium.

With this configuration, by increasing and decreasing the opening degree of the first flow rate adjuster and the opening degree of the second flow rate adjuster, it is possible to increase and decrease the flow rate of the heat medium in the first heat medium supply manifold and the flow rate of the heat medium in the second heat medium supply manifold. Therefore, it is possible to adjust the flow rate of the heat medium in the first heat medium supply manifold and the flow rate of the heat medium in the second heat medium supply manifold.

Moreover, a third fuel cell system of the present invention includes: the fuel cell having the first heat medium supply manifold, the second heat medium supply manifold, the first heat medium discharge sub-manifold, and the second heat medium discharge sub-manifold; a reactant gas supplying device configured to supply the reactant gas to the fuel cell; a first heat medium supplying device configured to supply the heat medium to the first heat medium supply manifold; a second heat medium supplying device configured to supply the heat medium to the second heat medium supply manifold; a first temperature detector configured to directly or indirectly detect the temperature of the heat medium flowing through the first heat medium discharge sub-manifold or the temperature of the heat medium discharged from the first heat medium discharge sub-manifold; a second temperature detector configured to directly or indirectly detect the temperature of the heat medium flowing through the second heat medium discharge sub-manifold or the temperature of the heat medium discharged from the second heat medium discharge sub-manifold; and a controller configured to control the first heat medium supplying device and the second heat medium supplying device.

The third fuel cell system of the present invention may further include an electric power circuit portion configured to take out the electric power from the fuel cell, wherein: the controller may cause the fuel cell to carry out an electric power generating mode in which the fuel cell generates the electric power and supplies the electric power to an external load and a start-up mode in which the fuel cell shifts from a stop state to the electric power generating mode; while one of the temperature of the heat medium detected by the first temperature detector and the temperature of the heat medium detected by the second temperature detector is lower than an electric power generation start temperature T₁ in the start-up mode, the controller may cause the first heat medium supplying device to supply the heat medium through the first heat medium supply manifold to the heat transferring portions of the end portions, and cause the second heat medium supplying device to supply the heat medium through the second heat medium supply manifold to the heat transferring portions of the remaining portion; when each of the temperature of the heat medium detected by the first temperature detector and the temperature of the heat medium detected by the second temperature detector is the electric power generation start temperature T₁ or higher, the controller may cause the reactant gas supplying device to supply the reactant gas to the fuel cell and cause the electric power circuit portion to take out the electric power; and when each of the temperature of the heat medium detected by the first temperature detector and the temperature of the heat medium detected by the second temperature detector is an electric power generation continuable temperature T₂ or higher which is higher than the electric power generation start temperature T₁, the controller may cause the fuel cell system to shift to the electric power generating mode.

In the third fuel cell system of the present invention, the controller may be configured to control an amount of heat medium supplied from the first heat medium supplying device and an amount of heat medium supplied from the second heat medium supplying device based on the temperature of the heat medium detected by the first temperature detector and the temperature of the heat medium detected by the second temperature detector.

With this configuration, in accordance with the temperature of the heat medium discharged from the first heat medium discharge sub-manifold and the temperature of the heat medium discharged from the second heat medium discharge sub-manifold, it is possible to increase and decrease the amount of heat medium supplied to the first heat medium supply manifold and/or the amount of heat medium supplied to the second heat medium supply manifold.

The third fuel cell system of the present invention may further include an electric power circuit portion configured to take out the electric power from the fuel cell, wherein: the controller may cause the fuel cell to carry out an electric power generating mode in which the fuel cell generates the electric power and supplies the electric power to an external load and a start-up mode in which the fuel cell shifts from a stop state to the electric power generating mode; while one of the temperature of the heat medium detected by the first temperature detector and the temperature of the heat medium detected by the second temperature detector is lower than an electric power generation start temperature T₁ in the start-up mode, the controller may cause the first heat medium supplying device to supply the heat medium through the first heat medium supply manifold to the heat transferring portions of the end portions, and cause the second heat medium supplying device to supply the heat medium through the second heat medium supply manifold to the heat transferring portions of the remaining portion; when each of the temperature of the heat medium detected by the first temperature detector and the temperature of the heat medium detected by the second temperature detector is the electric power generation start temperature T₁ or higher, the controller may cause the first heat medium supplying device to continue to supply the heat medium to the heat transferring portions of the end portions, cause the second heat medium supplying device to limit the amount of heat medium supplied to the heat transferring portions of the remaining portion, cause the reactant gas supplying device to supply the reactant gas to the fuel cell, and cause the electric power circuit portion to take out the electric power; and when each of the temperature of the heat medium detected by the first temperature detector and the temperature of the heat medium detected by the second temperature detector is an electric power generation continuable temperature T₂ or higher which is higher than the electric power generation start temperature T₁, the controller may cause the first heat medium supplying device to limit the amount of heat medium supplied through the first heat medium supply manifold to the heat transferring portions of the end portions, and cause the second heat medium supplying device to cancel limitation of the amount of heat medium supplied through the second heat medium supply manifold to the heat transferring portions of the remaining portion, to cause the fuel cell system to shift to the electric power generating mode.

With this configuration, in accordance with the temperature of the heat medium detected by the first temperature detector and the temperature of the heat medium detected by the second temperature detector, it is possible to control the temperature of the stack while increasing and decreasing the amount of heat medium supplied from the first heat medium supplying device and the amount of heat medium supplied from the second heat medium supplying device. Then, when the temperature of the entire stack is stabilized, the fuel cell can stably generate the electric power.

In the third fuel cell system of the present invention, the controller may stop supplying the heat medium to limit the amount of heat medium supplied.

In the third fuel cell system of the present invention, it is preferable that the temperature of the heat medium supplied from the first heat medium supplying device be higher than the temperature of the heat medium supplied from the second heat medium supplying device.

With this configuration, it is possible to quickly increase the temperatures of both end portions of the stack.

The third fuel cell system of the present invention may further include: a first external heat medium flow passage through which the heat medium discharged from the first heat medium discharge sub-manifold returns to the first heat medium supplying device; a second external heat medium flow passage through which the heat medium discharged from the second heat medium discharge sub-manifold returns to the second heat medium supplying device; a third external heat medium flow passage; a first flow passage selector disposed on a portion of the first external heat medium flow passage so as to be connected to the second heat medium supplying device by the third external heat medium flow passage, and configured to switch a destination to which the heat medium discharged from the first heat medium discharge sub-manifold flows, between the first heat medium supplying device and the second heat medium supplying device; a fourth external heat medium flow passage; and a second flow passage selector disposed on a portion of the second external heat medium flow passage so as to be connected to the first heat medium supplying device by the fourth external heat medium flow passage, and configured to switch a destination to which the heat medium discharged from the second heat medium discharge sub-manifold flows, between the second heat medium supplying device and the first heat medium supplying device, wherein after the controller causes the reactant gas supplying device to supply the reactant gas to the fuel cell and causes the electric power circuit portion to take out the electric power in the start-up mode, the controller may cause the first flow passage selector to supply the heat medium, having been discharged from the first heat medium discharge manifold, through the third external heat medium flow passage to the second heat medium supplying device to cause the second heat medium supplying device to continue to supply the heat medium through the second heat medium supply manifold to the heat transferring portions of the remaining portion, and cause the second flow passage selector to supply the heat medium, having been discharged from the second heat medium discharge manifold, through the fourth external heat medium flow passage to the first heat medium supplying device to cause the first heat medium supplying device to continue to supply the heat medium through the first heat medium supply manifold to the heat transferring portions of the end portions.

With this configuration, since the heat medium which has flowed through the heat transferring portions of the remaining portion of the stack and has recovered heat to increase in temperature is supplied to the first heat medium supplying device, and this heat medium is supplied to the end portions of the stack, it is possible to save the energy for increasing the temperature of the heat medium in the first heat medium supplying device.

The above object, other objects, features and advantages of the present invention will be made clear by the following detailed explanation of preferred embodiments with reference to the attached drawings.

### EFFECTS OF THE INVENTION

Each of the fuel cell and the fuel cell system according to the present invention can control the temperature of the stack at the time of both the start-up and the electric power generation.

### BRIEF DESCRIPTION OF THE DRAWINGS

FIG. 1 is a block diagram showing a schematic configuration of a fuel cell system of Embodiment 1 of the present invention.

FIG. 2 is a schematic diagram showing the configuration of a fuel cell for use in the fuel cell system of FIG. 1.

FIG. 3 is a perspective view of the fuel cell of FIG. 2.

FIG. 4 is a cross-sectional view taken along line IV-IV of FIG. 3.

FIG. 5 are diagrams showing the configurations of both main surfaces of an end portion cathode separator for use in the fuel cell of FIG. 2. FIG. 5(a) is a plan view showing the main surface on which an oxidizing gas channel is formed. FIG. 5(b) is a diagram showing a surface opposite to the surface of FIG. 5(a) and is a plan view showing the main surface on which a heat medium channel is formed.

FIG. 6 are plan views showing the configurations of both main surfaces of an end portion anode separator for use in the fuel cell of FIG. 2. FIG. 6(a) is a plan view showing the main surface on which a fuel gas channel is formed. FIG. 6(b) is a diagram showing a surface opposite to the surface of FIG. 6(a) and is a plan view showing the main surface on which the heat medium channel is formed.

FIG. 7 are plan views showing the configurations of both main surfaces of a remaining portion cathode separator for use in the fuel cell of FIG. 2. FIG. 7(a) is a plan view showing the main surface on which the oxidizing gas channel is formed. FIG. 7(b) is a diagram showing a surface opposite to the surface of FIG. 7(a) and is a plan view showing the main surface on which the heat medium channel is formed.

FIG. 8 are plan views showing the configurations of both main surfaces of a remaining portion anode separator for use in the fuel cell of FIG. 2. FIG. 8(a) is a plan view showing the main surface on which the fuel gas channel is formed. FIG. 8(b) is a diagram showing a surface opposite to the surface of FIG. 8(a) and is a plan view showing the main surface on which the heat medium channel is formed.

FIG. 9 is a flow chart showing a control program for controlling the fuel cell system of FIG. 1.

FIG. 10 is a block diagram showing a schematic configuration of the fuel cell system of Embodiment 2 of the present invention.

FIG. 11 is a schematic diagram showing the configuration of the fuel cell for use in the fuel cell system of FIG. 10.

FIG. 12 are plan views showing the configurations of both main surfaces of the end portion cathode separator for use in the fuel cell of FIG. 11. FIG. 12(a) is a plan view showing the main surface on which the oxidizing gas channel is formed. FIG. 12(b) is a diagram showing a surface opposite to the surface of FIG. 12(a) and is a plan view showing the main surface on which the heat medium channel is formed.

FIG. 13 are plan views showing the configurations of both main surfaces of the end portion anode separator for use in the fuel cell of FIG. 11. FIG. 13(a) is a plan view showing the main surface on which the fuel gas channel is formed. FIG. 13(b) is a diagram showing a surface opposite to the surface of FIG. 13(a) and is a plan view showing the main surface on which the heat medium channel is formed.

FIG. 14 are plan views showing the configurations of both main surfaces of the remaining portion cathode separator for use in the fuel cell of FIG. 11. FIG. 14(a) is a plan view showing the main surface on which the oxidizing gas channel is formed. FIG. 14(b) is a diagram showing a surface opposite to the surface of FIG. 14(a) and is a plan view showing the main surface on which the heat medium channel is formed.

FIG. 15 are plan views showing the configurations of both main surfaces of the remaining portion anode separator for use in the fuel cell of FIG. 11. FIG. 15(a) is a plan view showing the main surface on which the fuel gas channel is formed. FIG. 15(b) is a diagram showing a surface opposite to the surface of FIG. 15(a) and is a plan view showing the main surface on which the heat medium channel is formed.

FIG. 16 is a flow chart showing a control program for controlling the fuel cell system of FIG. 10.

FIG. 17 is a diagram showing Modification Example of Embodiment 2 and is a flow chart showing a control program for controlling the fuel cell system of FIG. 10.

FIG. 18 is a schematic diagram showing the configuration of the fuel cell for use in the fuel cell system of Embodiment 3 of the present invention.

FIG. 19 are plan views showing the configurations of both main surfaces of the remaining portion cathode separator for use in the fuel cell of FIG. 18. FIG. 19(a) is a plan view showing the main surface on which the oxidizing gas channel is formed. FIG. 19(b) is a diagram showing a surface opposite to the surface of FIG. 19(a) and is a plan view showing the main surface on which the heat medium channel is formed.

FIG. 20 are plan views showing the configurations of both main surfaces of the remaining portion anode separator for use in the fuel cell of FIG. 18. FIG. 20(a) is a plan view showing the main surface on which the fuel gas channel is formed. FIG. 20(b) is a diagram showing a surface opposite to the surface of FIG. 20(a) and is a plan view showing the main surface on which the heat medium channel is formed.

FIG. 21 is a block diagram showing a schematic configuration of the fuel cell system of Embodiment 4 of the present invention.

FIG. 22 is a schematic diagram showing the configuration of the fuel cell for use in the fuel cell system of FIG. 21.

FIG. 23 is a block diagram showing a schematic configuration of the fuel cell system of Embodiment 5 of the present invention.

FIG. 24 is a block diagram showing a schematic configuration of the fuel cell system of Embodiment 6 of the present invention.

FIG. 25 is a schematic diagram showing the configuration of the fuel cell for use in the fuel cell system of FIG. 24.

FIG. 26 is a block diagram showing a schematic configuration of the fuel cell system of Embodiment 7 of the present invention.

FIG. 27 is a flow chart showing a control program for controlling the fuel cell system of FIG. 26.

### EXPLANATION OF REFERENCE NUMBERS

1 cell stack (stack)
2 cell
3A, 3B end plate
4 oxidizing gas supply manifold
5 fuel gas supply manifold
6 fuel gas discharge manifold
7 oxidizing gas discharge manifold
8A first heat medium supply manifold
8B second heat medium supply manifold
9 heat medium discharge manifold
9A first heat medium discharge manifold
9B second heat medium discharge manifold
10 cathode separator
10A, 10C end portion cathode separator
10B, 10D remaining portion cathode separator
11, 21 oxidizing gas supply manifold hole
12, 22 fuel gas supply manifold hole
13, 23 oxidizing gas discharge manifold hole
14, 24 fuel gas discharge manifold hole
15A, 25A first heat medium supply manifold hole
15B, 25B second heat medium supply manifold hole
16A, 26A first heat medium discharge manifold hole
16B, 26B second heat medium discharge manifold hole
17 oxidizing gas channel
19, 29 heat medium channel
19A, 29A first heat medium channel
19B, 29B second heat medium channel
20 anode separator
20A, 20C end portion anode separator
20B, 20D remaining portion anode separator
28 fuel gas channel
30 heat medium supply pipe
30A first heat medium supply pipe
30B second heat medium supply pipe
31 branched portion
32 third heat medium supply pipe
41 polymer electrolyte membrane
42A cathode
42B anode
43 MEA member
46 gasket
47 O ring housing groove
47 O ring
51 oxidizing gas supply pipe
52 oxidizing gas discharge pipe
53 fuel gas supply pipe
54 fuel gas discharge pipe
55 heat medium discharge pipe
55A first heat medium discharge pipe
55B second heat medium discharge pipe
100, 200, 400, 500, 600, 700 fuel cell system
101, 201, 301, 401, 601 fuel cell
102 fuel gas supplying device (reactant gas supplying device)
103 oxidizing gas supplying device (reactant gas supplying device)
105, 205 cell stack body
107 oxidizing gas supply passage
109 fuel gas supply passage
110 fuel gas discharge passage
111 oxidizing gas discharge passage
112 external heat medium flow passage
112A first external heat medium flow passage
112B second external heat medium flow passage
113 heat medium flow passage
113A first heat medium flow passage
113B second heat medium flow passage
114 branched portion
115 bypass passage
116 fourth heat medium flow passage
117 third heat medium flow passage
118 bypassed portion (of external heat medium flow passage)
120 heat medium supplying device
120A first heat medium supplying device
120B second heat medium supplying device
125 T-shaped tube joint
125a first output port
125b second output port
125c input port
130A first on-off valve (first opening/closing device, first flow rate increasing/limiting device)
130B second on-off valve (second opening/closing device, second flow rate increasing/limiting device)
131A first flow rate control valve (first flow rate adjuster, first flow rate increasing/limiting device)
131B second flow rate control valve (second flow rate adjuster, second flow rate increasing/limiting device)
134 first three-way valve (first flow passage selector)
134a, 135a first port
134c, 135b second port
134b, 135c third port second three-way valve (second flow passage selector)
140 temperature detector
140A first temperature detector
140B second temperature detector
141 end portion temperature detector
143 remaining portion temperature detector
150 inverter (electric power circuit portion)
160 controller
161 storage portion
162 calculating portion
170 flow rate control valve (flow rate adjuster)
180 heat exchanger
401A first heat medium entrance
401B second heat medium entrance
402 heat medium exit
402A first heat medium exit
402B second heat medium exit
403 fuel gas entrance
404 oxidizing gas entrance
405 fuel gas exit
406 oxidizing gas exit
407 through hole
E end portion of stack
R remaining portion of stack
H heat transferring portion
H_{E} heat transferring portion of end portion
H_{R} heat transferring portion of remaining portion
P reacting portion

### BEST MODE FOR CARRYING OUT THE INVENTION

Hereinafter, embodiments of the present invention will be explained in reference to the drawings. Hereinafter, in all the drawings, same reference numbers are used for the same or corresponding components, and a repetition of the same explanation will be omitted.

### Embodiment 1

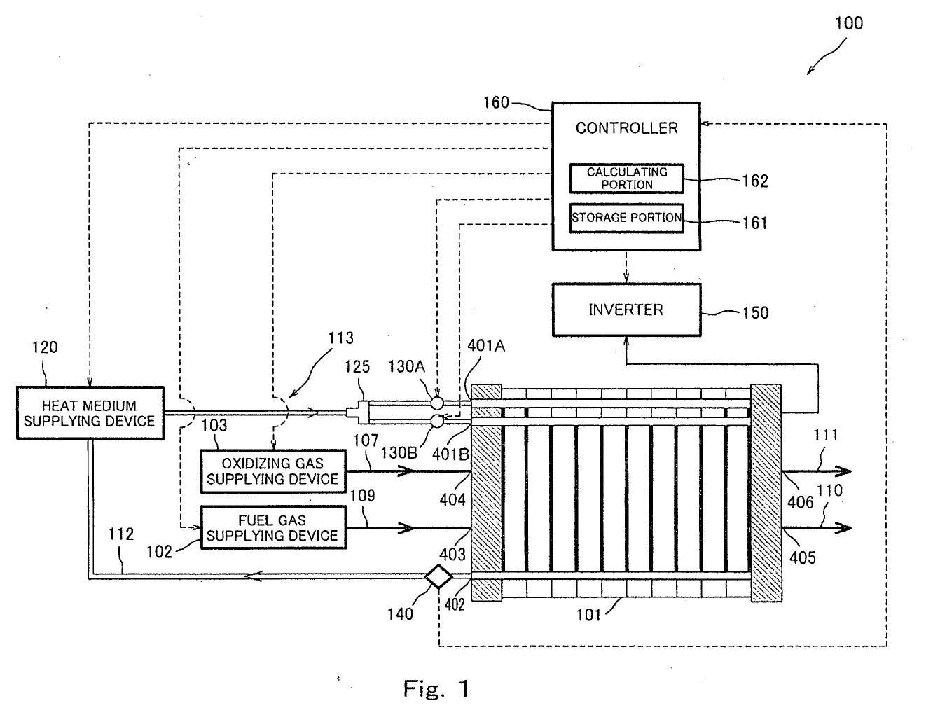

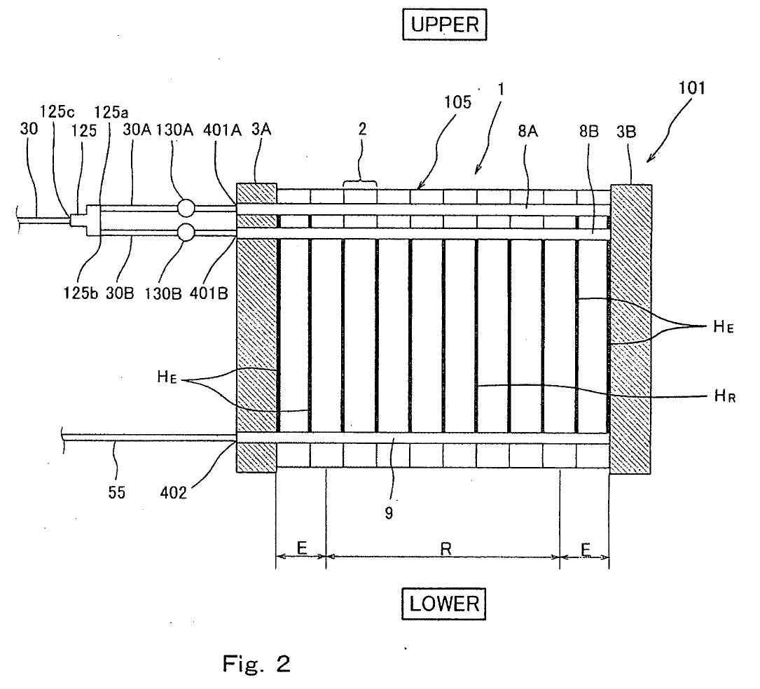

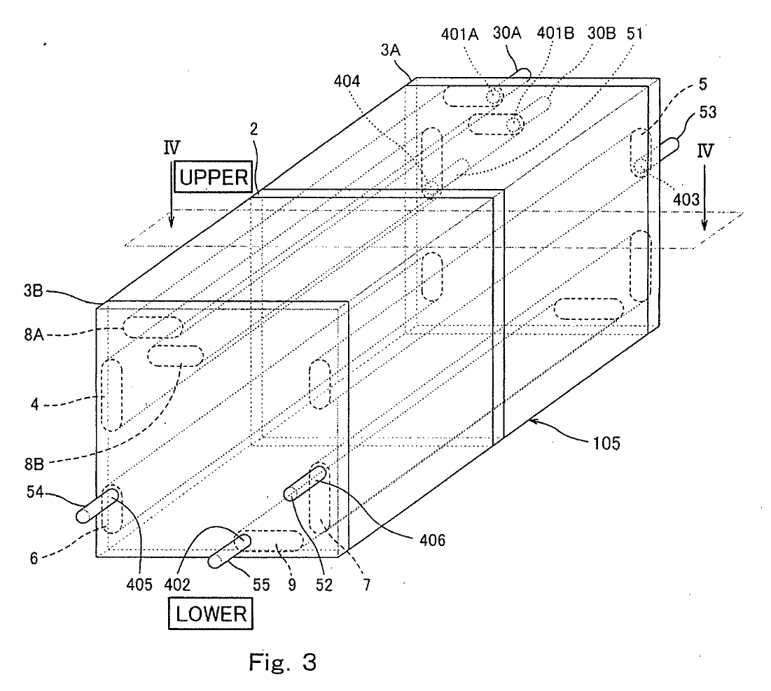

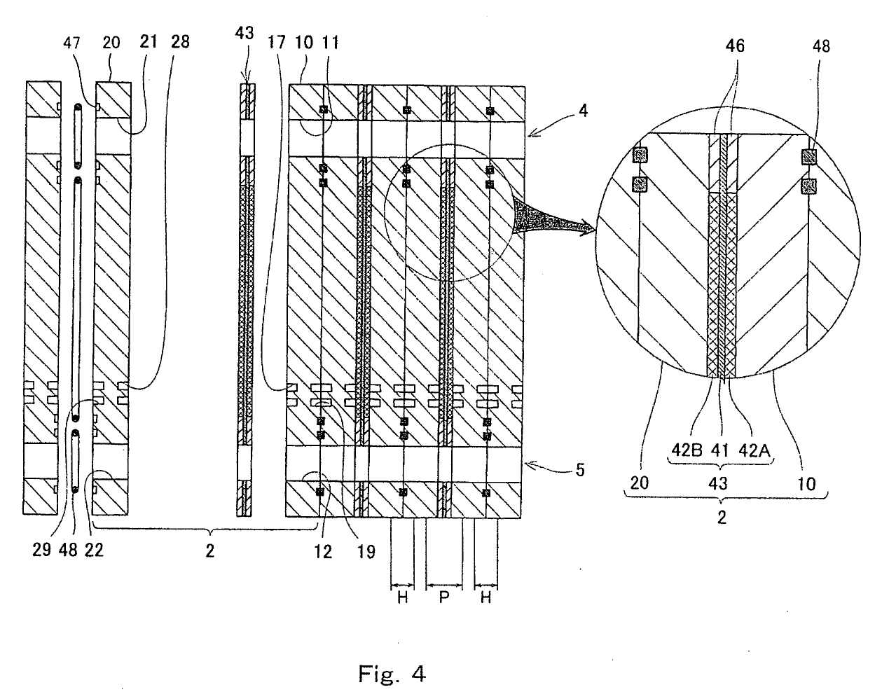

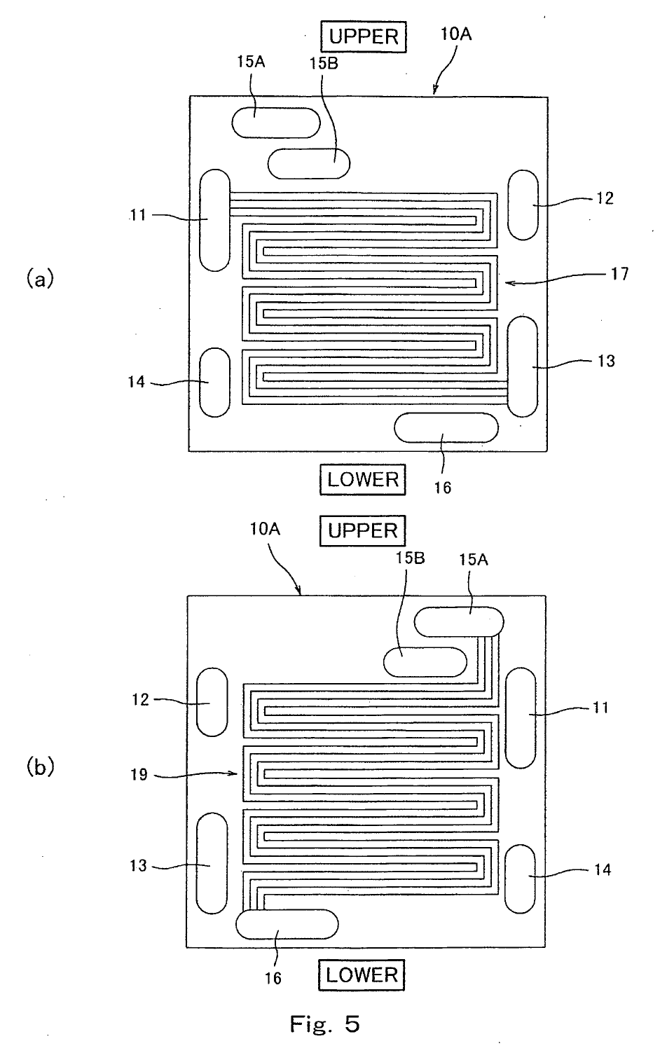

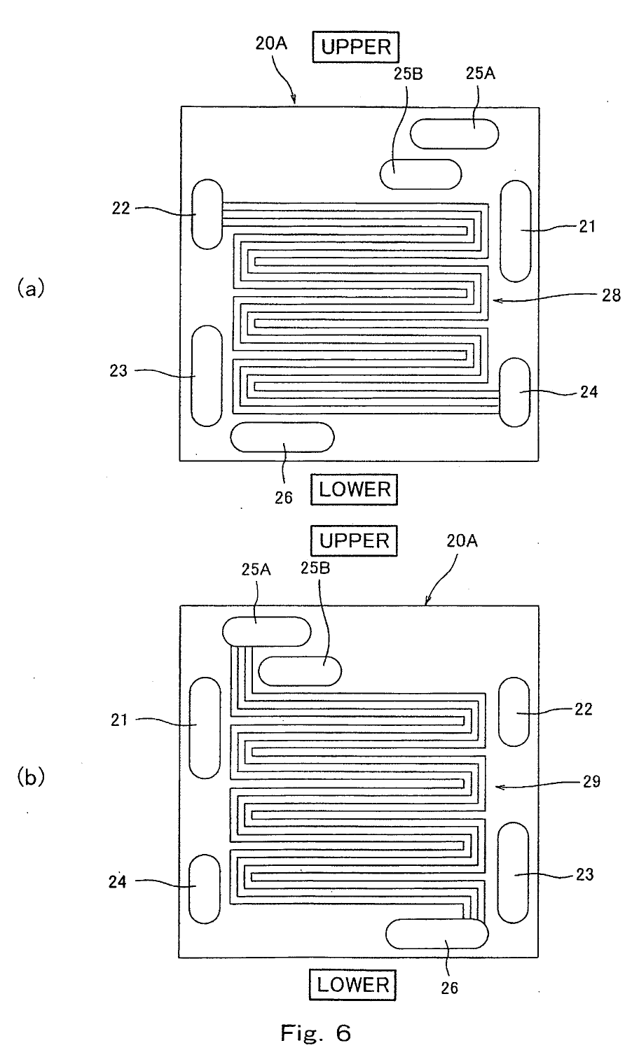

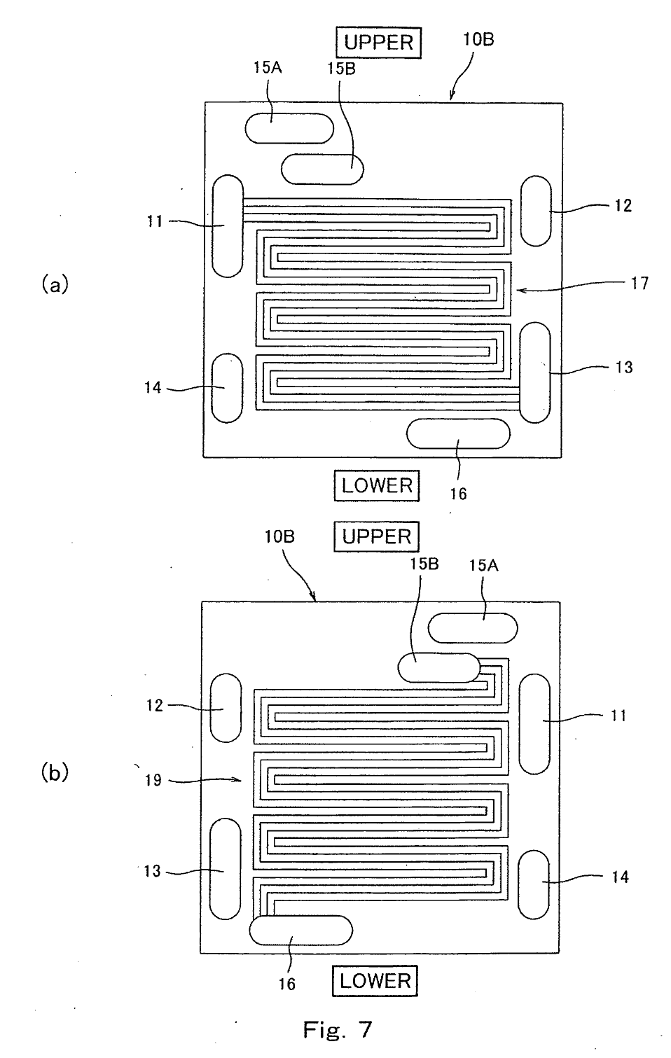

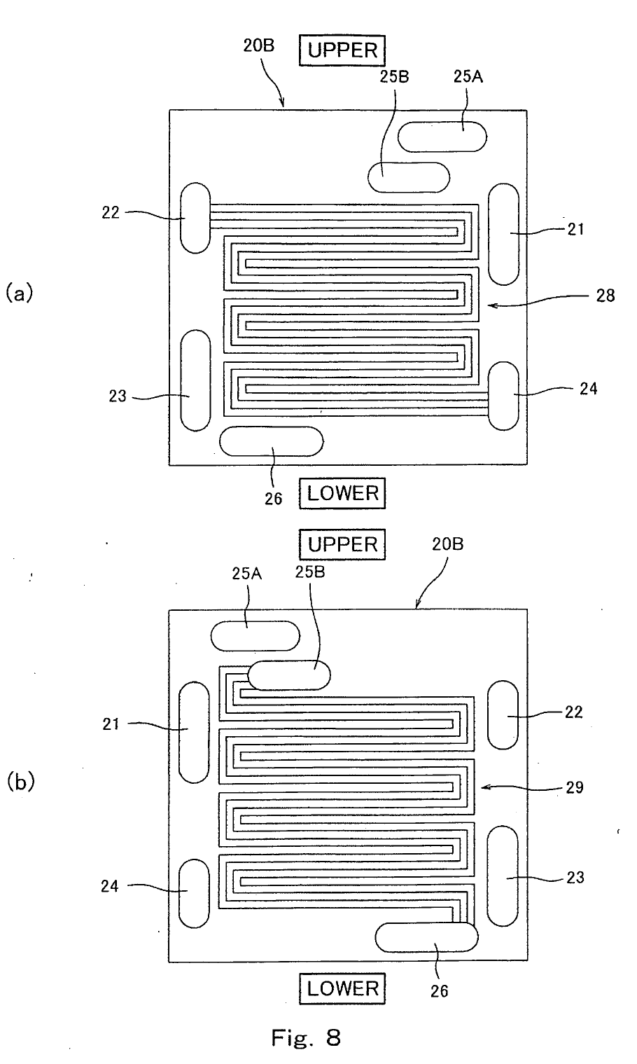

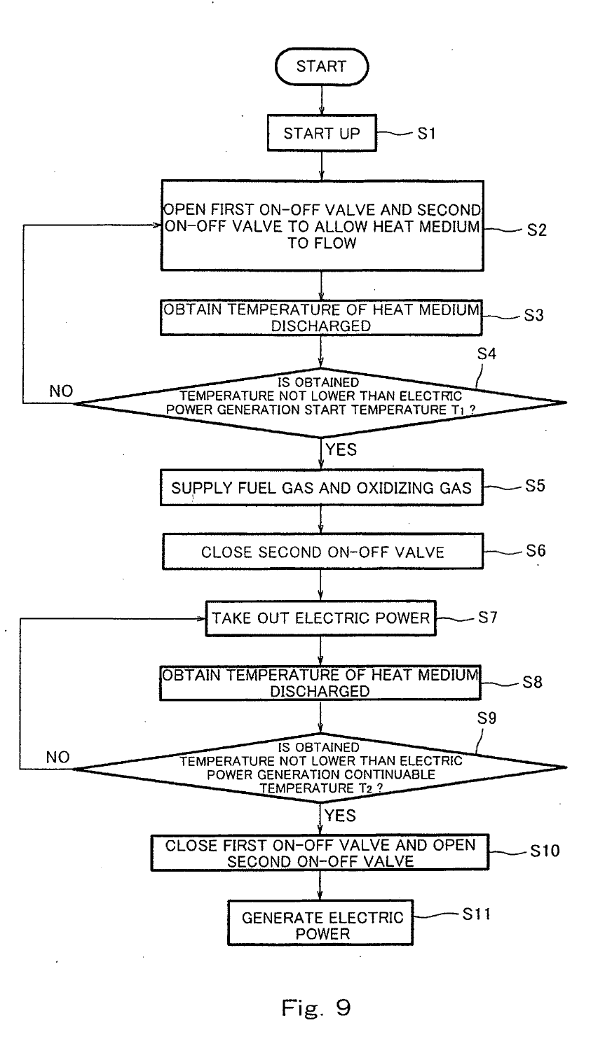

FIG. 1 is a block diagram showing a schematic configuration of a fuel cell system of Embodiment 1 of the present invention. FIG. 2 is a schematic diagram showing the configuration of a fuel cell for use in the fuel cell system of FIG. 1. FIG. 3 is a perspective view of the fuel cell of FIG. 2. FIG. 4 is a cross-sectional view taken along line IV-IV of FIG. 3. FIG. 5 are plan views showing the configurations of both main surfaces of an end portion cathode separator for use in the fuel cell of FIG. 2. FIG. 5(a) is a plan view showing the main surface on which an oxidizing gas channel is formed. FIG. 5(b) is a diagram showing a surface opposite to the surface of FIG. 5(a) and is a plan view showing the main surface on which a heat medium channel is formed. FIG. 6 are plan views showing the configurations of both main surfaces of an end portion anode separator for use in the fuel cell of FIG. 2. FIG. 6(a) is a plan view showing the main surface on which a fuel gas channel is formed. FIG. 6(b) is a diagram showing a surface opposite to the surface of FIG. 6(a) and is a plan view showing the main surface on which the heat medium channel is formed. FIG. 7 are plan views showing the configurations of both main surfaces of a remaining portion cathode separator for use in the fuel cell of FIG. 2. FIG. 7(a) is a plan view showing the main surface on which the oxidizing gas channel is formed. FIG. 7(b) is a diagram showing a surface opposite to the surface of FIG. 7(a) and is a plan view showing the main surface on which the heat medium channel is formed. FIG. 8 are plan views showing the configurations of both main surfaces of a remaining portion anode separator for use in the fuel cell of FIG. 2. FIG. 8(a) is a plan view showing the main surface on which the fuel gas channel is formed. FIG. 8(b) is a diagram showing a surface opposite to the surface of FIG. 8(a) and is a plan view showing the main surface on which the heat medium channel is formed. FIG. 9 is a flow chart showing a control program for controlling the fuel cell system of FIG. 1. Hereinafter, the fuel cell and the fuel cell system according to the present embodiment will be explained in reference to FIGS. 1 to 9.

As shown in FIG. 1, a fuel cell system 100 of the present embodiment includes a fuel cell 101. A fuel gas supplying device (reactant gas supplying device) 102 is connected by a fuel gas supply passage 109 to a fuel gas entrance 403, through which a fuel gas is supplied to an anode, of the fuel cell 101. The fuel gas supplying device 102 supplies the fuel gas to the anode of the fuel cell 101. For example, used as the fuel gas is a hydrogen gas, a reformed gas of a hydrocarbon based gas, or the like. In the present embodiment, the fuel gas supplying device 102 is constituted by a hydrogen generator which generates the reformed gas as the fuel gas from a material gas. Herein, used as the material gas is a natural gas.

An oxidizing gas supplying device (reactant gas supplying device) 103 is connected by an oxidizing gas supply passage 107 to an oxidizing gas entrance 404, through which an oxidizing gas is supplied to a cathode, of the fuel cell 101. The oxidizing gas supplying device 103 supplies the oxidizing gas to the cathode of the fuel cell 101. In the present embodiment, the oxidizing gas supplying device 103 is constituted by an air blower. Herein, used as the oxidizing gas is air. A chemical reaction between the fuel gas supplied to the anode of the fuel cell 101 and the oxidizing gas supplied to the cathode of the fuel cell 101 is carried out in the fuel cell 101 to generate electric power and heat.

A fuel gas discharge passage 110 is connected to a fuel gas exit 405, through which the fuel gas is discharged from the anode, of the fuel cell 101. The excess fuel gas which did not contribute to the above chemical reaction is discharged from the anode to the fuel gas discharge passage 110, and is processed suitably. For example, the excess fuel gas discharged to the fuel gas discharge passage 110 is used as a fuel for heating a reformer portion of the hydrogen generator constituting the fuel gas supplying device 102, is burned by a special burner, or is suitably diluted and released to the atmosphere.

Moreover, an oxidizing gas discharge passage 111 is connected to an oxidizing gas exit 406, through which the oxidizing gas is discharged from the cathode, of the fuel cell 101. The excess oxidizing gas which did not contribute to the above chemical reaction is released from the cathode through the oxidizing gas discharge passage 111 to the atmosphere.

Meanwhile, a heat medium flow passage 113 is formed in the fuel cell system 100 so as to pass through the fuel cell 101. The heat medium flow passage 113 is constituted by an internal heat medium flow passage formed inside the fuel cell 101 and an external heat medium flow passage 112 for supplying the heat medium to the internal heat medium flow passage. Note that the internal heat medium flow passage is constituted by first and second heat medium supply manifolds 8A and 8B, heat medium channels 19 and 29, and a heat medium discharge manifold 9, which will be described later. The external heat medium flow passage 112 is connected to a first heat medium entrance 401A, second heat medium entrance 401B, and heat medium exit 402 of the fuel cell 101. The external heat medium flow passage 112 is branched by a T-shaped tube joint 125 to be connected to the first heat medium entrance 401A and second heat medium entrance 401B of the fuel cell 101. A first on-off valve (first opening/closing device, first flow rate increasing/limiting device) 130A is disposed on the external heat medium flow passage 112 in the vicinity of the first heat medium entrance 401A. A second on-off valve (second opening/closing device, second flow rate increasing/limiting device) 130B is disposed on the external heat medium flow passage 112 in the vicinity of the second heat medium entrance 401B. The first on-off valve 130A opens and closes to allow and inhibit the flow of the heat medium to the first heat medium entrance 401A, and the second on-off valve 130B opens and closes to allow and inhibit the flow of the heat medium to the second heat medium entrance 401B. Note that water circulates through the heat medium flow passage 113 as the heat medium. For example, an antifreezing fluid may be used as the heat medium. A heat medium supplying device 120 and a temperature detector 140 are disposed on the external heat medium flow passage 112. The heat medium supplying device 120 includes a temperature adjuster, not shown, and can adjust to a predetermined temperature the temperature of the heat medium having circulated and returned. The temperature adjuster, not shown, includes, for example, a heater that is a portion functioning to heat the heat medium, and a radiator that is a portion functioning to cool down the heat medium. The temperature detector 140 is disposed on the external heat medium flow passage 112 in the vicinity of the heat medium exit 402. The temperature detector 140 is constituted by a known temperature sensor. The temperature detector 140 detects the temperature of the heat medium having flowed through the fuel cell 101 and then having been discharged from the heat medium exit 402.

An inverter (electric power circuit portion) 150 which converts DC power, generated by the fuel cell 101, into AC power is connected to the fuel cell 101. The inverter 150 is connected to an external load, not shown, and controls electric power supply to the external load (controls the electric power generated by the fuel cell 101).

The fuel cell system 100 of the present invention includes a controller 160. The controller 160 controls operations of the fuel gas supplying device 102, the oxidizing gas supplying device 103, the heat medium supplying device 120, the first on-off valve 130A, the second on-off valve 130B, the temperature detector 140, the inverter 150, and the like. The controller 160 includes a storage portion 161 and a calculating portion 162. The storage portion 161 stores, for example, a control program for controlling the operations of the fuel cell system 100. The calculating portion 162 loads the control program stored in the storage portion 161 and executes the program. The controller 160 is constituted by a processing unit, such as a microcomputer, and controls the above components of the fuel cell system 100 to control the operations of the fuel cell system 100. In the present specification, the controller 160 denotes not only a single controller but also a group of a plurality of controllers which executes operations in cooperation with one another. Therefore, the controller 160 does not have to be constituted by a single controller, but may be configured such that a plurality of controllers distributed control the operations of the fuel cell system 100 in cooperation with one another.

Next, the fuel cell 101 constituting the fuel cell system 100 of the present invention will be explained in detail in reference to FIG. 2.

As shown in FIG. 2, the fuel cell 101 includes a cell stack (stack) 1. The cell stack 1 includes: a cell stack body 105 formed by stacking cells 2, having a plate-shaped overall structure, in a thickness direction of the cell 2; first and second end plates 3A and 3B disposed on both ends, respectively, of the cell stack body 105; and fasteners (not shown) which fasten the cell stack body 105 and the first and second end plates 3A and 3B in a stack direction in which the cells 2 are stacked. In addition, current collecting terminals are formed on the first and second end plates 3A and 3B, respectively, but are not shown. The inverter 150 (see FIG. 1) is connected to a pair of these current collecting terminals. The plate-shaped cell 2 extends in parallel with a vertical surface, and therefore, the stack direction of the cells 2 is a horizontal direction.

The cell stack 1 is divided into end portions E that are both end portions in the stack direction of the cells 2, and a remaining portion R that is a portion other than the end portions E. Only the configurations of the separators constituting the cell 2 are slightly different between the end portion E and the remaining portion R. Therefore, hereinafter, the configurations of common components therebetween will be explained without distinction.

As shown in FIGS. 2 and 3, an oxidizing gas supply manifold 4 is formed at an upper portion of one side portion (hereinafter referred to as “first side portion”) of the cell stack body 105 so as to penetrate through the cell stack body 105 in the stack direction. One end of the oxidizing gas supply manifold 4 is communicated with a through hole formed on the first end plate 3A. An oxidizing gas supply pipe 51 constituting the oxidizing gas supply passage 107 of FIG. 1 is connected to an outside opening (oxidizing gas entrance 404) of the through hole. The other end of the oxidizing gas supply manifold 4 is closed by the second end plate 3B.

Moreover, an oxidizing gas discharge manifold 7 is formed at a lower portion of the other side portion (hereinafter referred to as “second side portion”) of the cell stack body 105 so as to penetrate through the cell stack body 105 in the stack direction. One end of the oxidizing gas discharge manifold 7 is closed by the first end plate 3A. The other end of the oxidizing gas supply manifold 7 is communicated with a through hole formed on the second end plate 3B. An oxidizing gas discharge pipe 52 constituting the oxidizing gas discharge passage 111 of FIG. 1 is connected to an outside opening (oxidizing gas exit 406) of the through hole.

A fuel gas supply manifold 5 is formed at an upper portion of the second side portion of the cell stack body 105 so as to penetrate through the cell stack body 105 in the stack direction. One end of the fuel gas supply manifold 5 is communicated with a through hole formed on the first end plate 3A. A fuel gas supply pipe 53 constituting the fuel gas supply passage 109 of FIG. 1 is connected to an outside opening (fuel gas entrance 403) of the through hole. The other end of the fuel gas supply manifold 5 is closed by the second end plate 3B.

Moreover, a fuel gas discharge manifold 6 is formed at a lower portion of the first side portion of the cell stack body 105 so as to penetrate through the cell stack body 105 in the stack direction. One end of the fuel gas discharge manifold 6 is closed by the first end plate 3A. The other end of the fuel gas discharge manifold 6 is communicated with a through hole formed on the second end plate 3B. A fuel gas discharge pipe 54 constituting the fuel gas discharge passage 110 of FIG. 1 is connected to an outside opening (fuel gas exit 405) of the through hole.

A first heat medium supply manifold 8A is formed above and inwardly of the oxidizing gas supply manifold 4 so as to penetrate through the cell stack body 105 in the stack direction. One end of the first heat medium supply manifold 8A is communicated with a through hole formed on the first end plate 3A. One end of a first heat medium supply pipe 30A constituting a part of the external heat medium flow passage 112 of FIG. 1 is connected to an outside opening (first heat medium entrance 401A) of the through hole. The first on-off valve 130A is disposed on the first heat medium supply pipe 30A in the vicinity of the first heat medium entrance 401A. The other end of the first heat medium supply pipe 30A is connected to a first output port 125a of the T-shaped tube joint 125. A heat medium supply pipe 30 constituting a part of the external heat medium flow passage 112 of FIG. 1 is connected to an input port 125c of the T-shaped tube joint 125. The heat medium supply pipe 30 and the first heat medium supply pipe 30A constitute a portion of the external heat medium flow passage 112 of FIG. 1 which portion extends between an outlet port (not shown) of the heat medium supplying device 120 and the first heat medium entrance 401A of the fuel cell 101. The other end of the first heat medium supply manifold 8A is closed by the second end plate 3B.

A second heat medium supply manifold 8B is formed above and inwardly of the oxidizing gas supply manifold 4 and below the first heat medium supply manifold 8A so as to penetrate through the cell stack body 105 in the stack direction. The first heat medium supply manifold 8A and the second heat medium supply manifold 8B are formed to be suitably spaced apart from each other to prevent the heat exchange between the heat medium flowing through the first heat medium supply manifold 8A and the heat medium flowing through the second heat medium supply manifold 8B. One end of the second heat medium supply manifold 8B is communicated with a through hole formed on the first end plate 3A. One end of a second heat medium supply pipe 30B constituting a part of the external heat medium flow passage 112 of FIG. 1 is connected to an outside opening (second heat medium entrance 401B) of the through hole. The second on-off valve 130B is disposed on the second heat medium supply pipe 30B in the vicinity of the second heat medium entrance 401B. The other end of the second heat medium supply pipe 30B is connected to a second output port 125b of the T-shaped tube joint 125. The other end of the second heat medium supply manifold 8B is closed by the second end plate 3B. The second heat medium supply pipe 30B constitutes a portion of the external heat medium flow passage 112 of FIG. 1 which portion extends between the T-shaped tube joint 125 and the second heat medium entrance 401B.

Moreover, the heat medium discharge manifold 9 is formed below and inwardly of the oxidizing gas discharge manifold 7 so as to penetrate through the cell stack body 105 in the stack direction. One end of the heat medium discharge manifold 9 is closed by the first end plate 3A. The other end of the heat medium discharge manifold 9 is communicated with a through hole formed on the second end plate 3B. A heat medium discharge pipe 55 constituting a part of the external heat medium flow passage 112 of FIG. 1 is connected to an outside opening (heat medium exit 402) of the through hole. The heat medium discharge pipe 55 constitutes a portion of the external heat medium flow passage 112 of FIG. 1 which portion extends between an inlet port (not shown) of the heat medium supplying device 120 and the fuel cell 101.

Next, the cell 2 constituting the cell stack 1 of the fuel cell 101 will be explained.

As shown in FIG. 4, the cell 2 is constituted by a plate-shaped MEA member 43, and a cathode separator 10 and an anode separator 20 disposed to contact both main surfaces, respectively, of the MEA member 43. The adjacent cells 2 are stacked each other such that a rear surface of the cathode separator 10 of one of the adjacent cells 2 and a rear surface of the anode separator 20 of the other cell 2 contact each other. The MEA member 43, the cathode separator 10, and the anode separator 20 are formed to be the same in size and shape (rectangular, herein) as one another. Then, an oxidizing gas supply manifold hole, an oxidizing gas discharge manifold hole, a fuel gas supply manifold hole, a fuel gas discharge manifold hole, a first heat medium supply manifold hole, a second heat medium supply manifold hole, and a heat medium discharge manifold hole are formed at predetermined positions of each of the MEA member 43, the cathode separator 10, and the anode separator 20 so as to penetrate through each of the MEA member 43, the cathode separator 10, and the anode separator 20 in the thickness direction, and the predetermined positions of the MEA member 43, the predetermined positions of the cathode separator 10, and the predetermined positions of the anode separator 20 correspond to one another. The oxidizing gas supply manifold holes, the oxidizing gas discharge manifold holes, the fuel gas supply manifold holes, the fuel gas discharge manifold holes, the first heat medium supply manifold holes, the second heat medium supply manifold holes, and the heat medium discharge manifold holes of the MEA members 43, the cathode separators 10, and the anode separators 20 of all the cells 2 are connected to one another to form the oxidizing gas supply manifold 4, the oxidizing gas discharge manifold 7, the fuel gas supply manifold 5, the fuel gas discharge manifold 6, the first heat medium supply manifold 8A, the second heat medium supply manifold 8B, and the heat medium discharge manifold 9, respectively.

An oxidizing gas channel 17 and a heat medium channel 19 are formed on a front surface and a rear surface, respectively, of the cathode separator 10. As will be described later, the oxidizing gas channel 17 is formed to cause the oxidizing gas supply manifold hole and the oxidizing gas discharge manifold hole to be communicated with each other. As will be described later, the heat medium channel 19 is formed to cause the first heat medium supply manifold hole or the second heat medium supply manifold hole, and the heat medium discharge manifold to be communicated with each other. The cathode separator 10 is disposed such that the front surface thereof contacts the MEA member 43.

A fuel gas channel 28 and a heat medium channel 29 are formed on a front surface and a rear surface, respectively, of the anode separator 20. As will be described later, the fuel gas channel 28 is formed to cause the fuel gas supply manifold hole and the fuel gas discharge manifold hole to be communicated with each other. As will be described later, the heat medium channel 29 is formed to cause the first heat medium supply manifold hole or the second heat medium supply manifold hole, and the heat medium discharge manifold to be communicated with each other. The anode separator 20 is disposed such that the front surface thereof contacts the MEA member 43.

Each of the channels 17, 19, 28, and 29 is constituted by a groove formed on the main surface of the cathode separator 10 or the anode separator 20. In FIG. 4, each of the channels 17, 19, 28, and 29 is constituted by two channels, but may be constituted by a large number of channels. Moreover, the heat medium channel 19 of the cathode separator 10 and the heat medium channel 29 of the adjacent anode separator 20 are formed to be joined to each other (contact each other) when the cells 2 are stacked. These channels 19 and 29 form one heat medium channel.

Moreover, O ring housing grooves 47 are formed on the rear surface of each separator so as to surround (i) the first or second heat medium supply manifold hole, (ii) a group of the second or first heat medium supply manifold hole, the heat medium discharge manifold hole, and the heat medium channel, (iii) the oxidizing gas supply manifold hole, (iv) the oxidizing gas discharge manifold hole, (v) the fuel gas supply manifold hole, and (vi) the fuel gas discharge manifold hole, respectively. O rings 48 are disposed in these grooves, respectively. With this, the manifold holes and the like are sealed.

The MEA member 43 includes a polymer electrolyte membrane 41, a cathode 42A, an anode 42B, and a pair of gaskets 46. The cathode 42A is formed on one surface of the polymer electrolyte membrane 41 so as to be located on a portion other than an edge portion of the polymer electrolyte membrane 41, and the anode 42B is formed on the other surface of the polymer electrolyte membrane 41 so as to be located on a portion other than the edge portion of the polymer electrolyte membrane 41. Gaskets 46 are disposed on both surfaces, respectively, of the edge portion of the polymer electrolyte membrane 41 so as to surround the cathode 42A and the anode 42B, respectively. The pair of gaskets 46, the cathode 42A, the anode 42B, and the polymer electrolyte membrane 41 are integral with one another.

The polymer electrolyte membrane 41 is formed by a material capable of selectively transporting hydrogen ions. Herein, the polymer electrolyte membrane 41 is formed by a perfluorocarbon sulfonic acid based material. The cathode 42A is constituted by a catalyst layer (not shown) formed on one main surface of the polymer electrolyte membrane 41, and a gas diffusion layer (not shown) formed on the catalyst layer. The anode 42B is constituted by a catalyst layer (not shown) formed on the other main surface of the polymer electrolyte membrane 41, and a gas diffusion layer (not shown) formed on the catalyst layer. The catalyst layer is mainly formed by carbon powder carrying platinum-based metal catalysts. The gas diffusion layer is formed by nonwoven fabric, paper, or the like having gas permeability and electron conductivity.

Moreover, the cathode 42A, the anode 42B, a region on the cathode separator 10 where the oxidizing gas channel 17 is formed, a region on the cathode separator 10 where the heat medium channel 19 is formed, a region on the anode separator 20 where the fuel gas channel 28 is formed, and a region on the anode separator 20 where the heat medium channel 29 is formed are arranged so as to substantially entirely overlap one another in the stack direction of the cells.

Next, the separators will be explained. There are two types of separators, i.e., a separator for the end portion and a separator for the remaining portion. Hereinafter, an end portion cathode separator 10A, an end portion anode separator 20A, a remaining portion cathode separator 10B, and a remaining portion anode separator 20B will be explained in detail.

As shown in FIG. 5, the end portion cathode separator 10A includes the oxidizing gas supply manifold hole 11, the oxidizing gas discharge manifold hole 13, the fuel gas supply manifold hole 12, the fuel gas discharge manifold hole 14, the first heat medium supply manifold hole 15A, the second heat medium supply manifold hole 15B, and a heat medium discharge manifold hole 16. Further, the end portion cathode separator 10A includes on its surface (front surface) opposed to the cathode, the oxidizing gas channel 17 which causes the oxidizing gas supply manifold hole 11 and the oxidizing gas discharge manifold hole 13 to be communicated with each other, and on its rear surface, the heat medium channel 19 which causes the first heat medium supply manifold hole 15A and the heat medium discharge manifold hole 16 to be communicated with each other. In FIG. 5(a), the oxidizing gas channel 17 is formed by two channels in the present embodiment. Of course, the oxidizing gas channel 17 may be formed by any number of channels. Each channel is formed in a serpentine shape. In FIG. 5(b), the heat medium channel 19 is formed by two channels in the present embodiment. Of course, the heat medium channel 19 may be formed by any number of channels. Each channel is formed in a serpentine shape.

In FIGS. 5(a) and 5(b), the oxidizing gas supply manifold hole 11 is formed at an upper portion of one side portion (side portion on a left side in FIG. 5(a); hereinafter referred to as “first side portion”) of the end portion cathode separator 10A. The oxidizing gas discharge manifold hole 13 is formed at a lower portion of the other side portion (side portion on a right side in FIG. 5(a); hereinafter referred to as “second side portion”) of the end portion cathode separator 10A. The fuel gas supply manifold hole 12 is formed at an upper portion of the second side portion of the end portion cathode separator 10A. The fuel gas discharge manifold hole 14 is formed at a lower portion of the first side portion of the end portion cathode separator 10A. The first heat medium supply manifold hole 15A is formed above and inwardly of the oxidizing gas supply manifold hole 11. The second heat medium supply manifold hole 15B is formed above and inwardly of the oxidizing gas supply manifold hole 11 and below the first heat medium supply manifold hole 15A. The heat medium discharge manifold hole 16 is formed below and inwardly of the oxidizing gas discharge manifold hole 13.

As shown in FIG. 6, the end portion anode separator 20A includes the oxidizing gas supply manifold hole 21, the oxidizing gas discharge manifold hole 23, the fuel gas supply manifold hole 22, the fuel gas discharge manifold hole 24, the first heat medium supply manifold hole 25A, the second heat medium supply manifold hole 25B, and a heat medium discharge manifold hole 26. Further, the end portion anode separator 20A includes on its surface opposed to the anode, the fuel gas channel 28 which causes the fuel gas supply manifold hole 22 and the fuel gas discharge manifold hole 24 to be communicated with each other, and on its rear surface, the heat medium channel 29 which causes the first heat medium supply manifold hole 25A and the heat medium discharge manifold hole 26 to be communicated with each other. In FIG. 6(a), the fuel gas channel 28 is formed by two channels in the present embodiment. Of course, the fuel gas channel 28 may be formed by any number of channels. Each channel is formed in a serpentine shape. In FIG. 6(b), the heat medium channel 29 is formed by two channels in the present embodiment. Of course, the heat medium channel 29 may be formed by any number of channels. Each channel is formed in a serpentine shape.

In FIGS. 6(a) and 6(b), the oxidizing gas supply manifold hole 21 is formed at an upper portion of one side portion (side portion on the right side in FIG. 6(a); hereinafter referred to as “first side portion”) of the end portion anode separator 20A. The oxidizing gas discharge manifold hole 23 is formed at a lower portion of the other side portion (side portion on the left side in FIG. 6(a); hereinafter referred to as “second side portion”) of the end portion anode separator 20A. The fuel gas supply manifold hole 22 is formed at an upper portion of the second side portion of the end portion anode separator 20A. The fuel gas discharge manifold hole 24 is formed at a lower portion of the first side portion of the end portion anode separator 20A. The first heat medium supply manifold hole 25A is formed above and inwardly of the oxidizing gas supply manifold hole 21. The second heat medium supply manifold hole 25B is formed above and inwardly of the oxidizing gas supply manifold hole 21 and below the first heat medium supply manifold hole 25A. The heat medium discharge manifold hole 26 is formed below and inwardly of the oxidizing gas discharge manifold hole 23.

As shown in FIG. 7, the remaining portion cathode separator 10B is formed in the same manner as the end portion cathode separator 10A except that an upstream end of the heat medium channel 19 formed on the rear surface of the remaining portion cathode separator 10B is connected not to the first heat medium supply manifold hole 15A but to the second heat medium supply manifold hole 15B.

As shown in FIG. 8, the remaining portion anode separator 20B is formed in the same manner as the end portion anode separator 20A except that an upstream end of the heat medium channel 29 formed on the rear surface of the remaining portion anode separator 20B is connected not to the first heat medium supply manifold hole 25A but to the second heat medium supply manifold hole 25B.

As described above, the oxidizing gas supply manifold holes 11 and 21 of respective separators constitute a part of the oxidizing gas supply manifold 4. The oxidizing gas discharge manifold holes 13 and 23 of respective separators constitute a part of the oxidizing gas discharge manifold 7. The fuel gas supply manifold holes 12 and 22 of respective separators constitute a part of the fuel gas supply manifold 5. The fuel gas discharge manifold holes 14 and 24 of respective separators constitute a part of the fuel gas discharge manifold 6. The first heat medium supply manifold holes 15A and 25A of respective separators constitute a part of the first heat medium supply manifold 8A. The second heat medium supply manifold holes 15B and 25B of respective separators constitute a part of the second heat medium supply manifold 8B. The heat medium discharge manifold holes 16 and 26 of respective separators constitute a part of the heat medium discharge manifold 9.

Next, the configurations of both end portions E and the remaining portion R of the cell stack 1 will be explained (see FIGS. 2 and 4).

At the end portion E, the end portion cathode separator 10A and the end portion anode separator 20A sandwich the MEA member 43 to form a reacting portion P and a heat transferring portion H. At the remaining portion R, the reacting portion P and the heat transferring portion H are formed as below. To be specific, at a portion of the remaining portion R which portion is adjacent to one end portion E, the end portion cathode separator 10A and the remaining portion anode separator 20B sandwich the MEA member 43 to form the reacting portion P, and at a portion of the remaining portion R which portion is adjacent to the other end portion E, the end portion anode separator 20A and the remaining portion cathode separator 10B sandwich the MEA member 43 to form the reacting portion P. At a portion of the remaining portion R other than the above portions, the remaining portion cathode separator 10B and the remaining portion anode separator 20B sandwich the MEA member 43 to form the reacting portion P and the heat transferring portion H. A portion from the cathode gas channel 17 formed on the end portion cathode separator 10A to the anode gas channel 28 formed on the end portion anode separator 20A constitutes the reacting portion P of each of both end portions E of the cell stack 1. Each of a portion where the heat medium channel 19 formed on the end portion cathode separator 10A and any end plate contacts each other, a portion where the heat medium channel 29 formed on the end portion anode separator 20A and any end plate contact each other, and a portion where the heat medium channel 19 formed on the end portion cathode separator 10A and the heat medium channel 29 formed on the end portion anode separator 20A contact each other constitutes a heat transferring portion H_{E} at the end portion E of the cell stack 1. In the present embodiment, the number of heat transferring portions H_{E} at each of both end portions E of the cell stack 1 is two. It is preferable that in a case where the cell stack 1 is formed by stacking twenty or more cells 2, the number of heat transferring portions H_{E} at each of both end portions E of the cell stack 1 be in a range of one to five. Moreover, it is preferable that the number of heat transferring portions H_{E} at each of both end portions E of the cell stack 1 be not less than 1% and not more than 25% of the number of cells stacked in the cell stack 1. According to results of experiments by the present inventors, it is preferable that at least two cells 2 (heat transferring portion) from each of both ends of the cell stack 1 be handled as the end portion E.

Moreover, a portion from the cathode gas channel 17 formed on the remaining portion cathode separator 10B to the anode gas channel 28 formed on the remaining portion anode separator 20B constitutes the reacting portion P of the remaining portion R of the cell stack 1. A portion where the heat medium channel 19 formed on the remaining portion cathode separator 10B and the heat medium channel 29 formed on the remaining portion anode separator 20B contact each other constitutes a heat transferring portion H_{R} of the remaining portion R of the cell stack 1.

In the case of forming the heat transferring portion for every plural cells, a single separator whose one surface serves as the cathode separator and whose other surface serves as the anode separator is suitably used instead of the above combined separators.

In the fuel cell 101 configured as above, the fuel gas, the oxidizing gas, and the heat medium flow as below.

In FIGS. 1 to 4, the fuel gas flows through the fuel gas supply passage 109 (fuel gas supply pipe 53) and is supplied from the fuel gas entrance 403 to the fuel gas supply manifold 5 of the cell stack 1. The supplied fuel gas flows from the fuel gas supply manifold 5 into the fuel gas supply manifold hole 22 of each cell 2, and flows through the fuel gas channel 28. In this period, the fuel gas reacts with the oxidizing gas to be consumed by the anode 42B, the polymer electrolyte membrane 41, and the cathode 42A. The unconsumed fuel gas flows out from the fuel gas discharge manifold hole 24 to the fuel gas discharge manifold 6, and is discharged from the fuel gas exit 405 through the fuel gas discharge passage 110 (fuel gas discharge pipe 54) to the outside of the cell stack 1.

Meanwhile, the oxidizing gas flows through the oxidizing gas supply passage 107 (oxidizing gas supply pipe 51) and is supplied from the oxidizing gas entrance 404 to the oxidizing gas supply manifold 4 of the cell stack 1. The supplied oxidizing gas flows from the oxidizing gas supply manifold 4 into the oxidizing gas supply manifold hole 11 of each cell 2, and flows through the oxidizing gas channel 17. In this period, the oxidizing gas reacts with the fuel gas to be consumed by the cathode 42A, the polymer electrolyte membrane 41, and the anode 42B. The unconsumed oxidizing gas flows out from the oxidizing gas discharge manifold hole 13 to the oxidizing gas discharge manifold 7, and is discharged from the oxidizing gas exit 406 through the oxidizing gas discharge passage 111 (oxidizing gas discharge pipe 52) to the outside of the cell stack 1.

Moreover, the heat medium flows through the external heat medium flow passage 112 (heat medium supply pipes 30 and 30A) and is supplied from the first heat medium entrance 401A to the first heat medium supply manifold 8A of the cell stack 1, and in addition, flows through the external heat medium flow passage 112 (heat medium supply pipes 30 and 30B) and is supplied from the second heat medium entrance 401B to the second heat medium supply manifold 8B of the cell stack 1.

The heat medium having been supplied to the first heat medium supply manifold 8A flows from the first heat medium supply manifold 8A to the first heat medium supply manifold holes 15A and 25A of each cell 2 of the end portion E, and flows through the heat transferring portion H_{E} (heat medium channels 19 and 29) of the end portion E. In this period, the heat medium exchanges heat with the cathode and the anode of the end portion E via the end portion cathode separator 10A and the end portion anode separator 20A, and flows out from the heat medium discharge manifold holes 16 and 26 to the heat medium discharge manifold 9. Then, the heat medium is discharged from the heat medium exit 402 through the external heat medium flow passage 112 (heat medium discharge pipe 55) to the outside of the cell stack 1.

Meanwhile, the heat medium having been supplied to the second heat medium supply manifold 8B flows from the second heat medium supply manifold 8B to the second heat medium supply manifold holes 15B and 25B of each cell 2 of the remaining portion R, and flows through the heat transferring portion H_{R} (heat medium channels 19 and 29) of the remaining portion R. In this period, the heat medium exchanges heat with the cathode and the anode of the remaining portion R via the remaining portion cathode separator 10B and the remaining portion anode separator 20B, and flows out from the heat medium discharge manifold holes 16 and 26 to the heat medium discharge manifold 9. Then, the heat medium is discharged from the heat medium exit 402 through the external heat medium flow passage 112 (heat medium discharge pipe 55) to the outside of the cell stack 1.

Next, operations of the fuel cell system 100 of the present embodiment will be explained. The fuel cell system 100 has an electric power generating mode in which the fuel cell system 100 generates the electric power by the fuel cell 101 and supplies the electric power to the external load, and a start-up mode in which the fuel cell system 100 shifts from a stop state to the electric power generating mode. Hereinafter, these modes of the fuel cell system 100 will be explained. Note that the following operations of the fuel cell system 100 will be realized by the controller 160. Specifically, the following operations of the fuel cell system 100 will be realized by the calculating portion 162 which executes the control program stored in the storage portion 161 of the controller 160.

As shown in FIG. 9, the controller 160 starts up the fuel cell system 100 (Step S1). Next, the controller 160 opens the first on-off valve 130A and the second on-off valve 130B (Step S2). With this, the heat medium flows through the first heat medium supply manifold 8A to the heat transferring portion H_{E} of the end portion E of the cell stack 1, and in addition, the heat medium flows through the second heat medium supply manifold 8B to the heat transferring portion H_{R} of the remaining portion R of the cell stack 1. In the present embodiment, the temperature of the heat medium is set to 60° C. With this, the entire cell stack 1 is quickly warmed up.

Next, the controller 160 obtains by the temperature detector 140 the temperature of the heat medium discharged from the heat medium discharge manifold 9 (Step S3). Then, the controller 160 determines whether or not the obtained temperature of the heat medium is not lower than an electric power generation start temperature T₁ (Step S4). In a case where the obtained temperature of the heat medium is lower than the electric power generation start temperature T₁, the heat medium continues to flow, and Steps S2 to S4 are repeated until the temperature of the heat medium becomes the electric power generation start temperature T₁ or higher. In the present embodiment, the electric power generation start temperature T₁ is set to 55° C. Here, the electric power generation start temperature T₁ is set to a temperature at which flooding does not occur in the fuel cell 101. It is preferable that the electric power generation start temperature T₁ be set in a range of 50° C. to 55° C. for example.

In a case where the obtained temperature of the heat medium is the electric power generation start temperature T₁ or higher in Step S4, the controller 160 causes the fuel gas supplying device 102 to supply the fuel gas to the anode of the fuel cell 101 and causes the oxidizing gas supplying device 103 to supply the oxidizing gas to the cathode of the fuel cell 101 (Step S5). Then, the controller 160 closes the second on-off valve 130B (Step S6). With this, the flow of the heat medium to the heat transferring portion H_{R} of the remaining portion R stops.

Then, the controller 160 takes out the electric power from the fuel cell 101 by the inverter 150 (Step S7). With this, the chemical reaction between the fuel gas and the oxidizing gas generates reaction heat from the reacting portion P. The temperature of the cell stack 1 increases by the reaction heat. At this time, in a case where the heat medium continues to flow through both the heat transferring portion H_{R} of the remaining portion R and the heat transferring portion H_{E} of the end portion E, the remaining portion R largely increases in temperature since the remaining portion R does not release heat. Therefore, the remaining portion R and the end portion E nonuniformly increases in temperature. However, in the present embodiment, since the flow of the heat medium to the heat transferring portion H_{R} of the remaining portion R is stopped at this time, the remaining portion R and the end portion E uniformly increase in temperature.

Then, the controller 160 obtains by the temperature detector 140 the temperature of the heat medium discharged from the heat medium discharge manifold 9 (Step S8). The controller 160 determines whether or not the obtained temperature of the heat medium is not lower than an electric power generation continuable temperature T₂ (Step S9). In a case where the obtained temperature of the heat medium is lower than the electric power generation continuable temperature T₂, the controller 160 continues to take out the electric power from the fuel cell 101 (Step S7), and repeats Steps S7 to S9 until the obtained temperature of the heat medium becomes the electric power generation continuable temperature T₂ or higher. In the present embodiment, the electric power generation continuable temperature T₂ is set to 65° C. That is, the electric power generation continuable temperature T₂ is higher than the electric power generation start temperature T₁. Here, it is preferable that the electric power generation continuable temperature T₂ be set in a range of 65° C. to 70° C.

In a case where the obtained temperature of the heat medium is the electric power generation continuable temperature T₂ or higher in Step S9, the controller 160 closes the first on-off valve 130A and opens the second on-off valve 130B (Step S10) to stop the flow of the heat medium to the heat transferring portion H_{E} of the end portion E and start the flow of the heat medium to the heat transferring portion H_{R} of the remaining portion R. With this, the fuel cell system 100 terminates the start-up mode (Step S10), shifts to the electric power generating mode, and generates the electric power in the fuel cell 101 (Step S11). In this state, since the temperature of the cell stack 1 is higher than the temperature (60° C.) of the heat medium supplied from the heat medium supplying device 120, the remaining portion R is cooled down by the heat medium flowing through the remaining portion R of the cell stack 1. Meanwhile, since the flow of the heat medium to the end portion E of the cell stack 1 is stopped, the end portion E is not cooled down by the heat medium and is cooled down only by the heat release. As a result, the remaining portion R is cooled down by the heat medium to a required level, and the end portion E becomes a substantially appropriate temperature by the heat release. With this, the fuel cell 101 stably carries out the electric power generation.

Since the fuel cell system 100 of the present embodiment is configured as above, the temperatures of the end portions E which release much heat from the end plates 3A and 3B can be increased in the start-up mode by preferentially causing the heat medium to flow through the heat transferring portions H_{E} of the end portions E of the cell stack 1. In contrast, the heat transferring portions H_{R} of the remaining portion R which releases less heat and generates much heat can be cooled down to a required level in the electric power generating mode by preferentially causing the heat medium to flow through the heat transferring portions H_{R} of the remaining portion R of the cell stack 1. As above, it is possible to selectively supply the heat medium to the heat transferring portion H_{E} of the end portion E of the cell stack 1 and the heat transferring portion H_{R} of the remaining portion R of the cell stack 1 at the time of both the start-up and the electric power generation. With this, it is possible to realize quick start-up and stable electric power generation of the fuel cell system 100.

In the fuel cell system 100 of the present embodiment, a first temperature adjuster (not shown) may be disposed on the first heat medium supply pipe 30A extending between the T-shaped tube joint 125 and the first heat medium entrance 401A, and a second temperature adjuster (not shown) may be disposed on the second heat medium supply pipe 30B extending between the T-shaped tube joint 125 and the second heat medium entrance 401B. With this, when the heat medium supplied by the heat medium supplying device 120 flows through the first heat medium supply pipe 30A, the temperature of the heat medium is readjusted by the first temperature adjuster, and when the heat medium supplied by the heat medium supplying device 120 flows through the second heat medium supply pipe 30B, the temperature of the heat medium is readjusted by the second temperature adjuster. Therefore, in a case where the heat medium flows through the first heat medium supply manifold 8A to the heat transferring portion H_{E} of the end portion E of the cell stack 1 and the heat medium flows through the second heat medium supply manifold 8B to the heat transferring portion H_{R} of the remaining portion R of the cell stack 1 in the start-up mode (Step S2), the heat medium supplied to the heat transferring portion H_{E} of the end portion E and the heat medium supplied to the heat transferring portion H_{R} of the remaining portion R can be made different in temperature from each other. Especially, by causing the higher-temperature heat medium to flow to the heat transferring portions H_{E} of the end portions E which release much heat from the end plates 3A and 3B, it is possible to quickly increase the temperatures of the end portions E of the cell stack 1.

Further, in the case of readjusting the temperature of the heat medium flowing through any one of the end portions E of the cell stack 1 and the remaining portion R of the cell stack 1, a temperature adjuster (not shown) may be disposed on any one of the first heat medium supply pipe 30A extending between the T-shaped tube joint 125 and the first heat medium entrance 401A and the second heat medium supply pipe 30B extending between the T-shaped tube joint 125 and the second heat medium entrance 401B.

### Embodiment 2

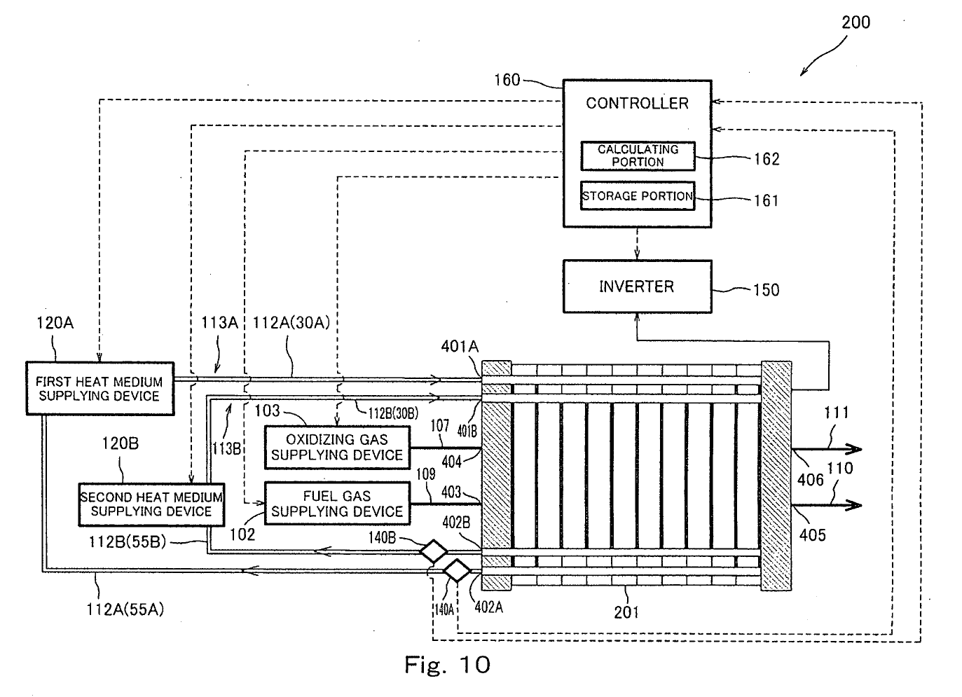

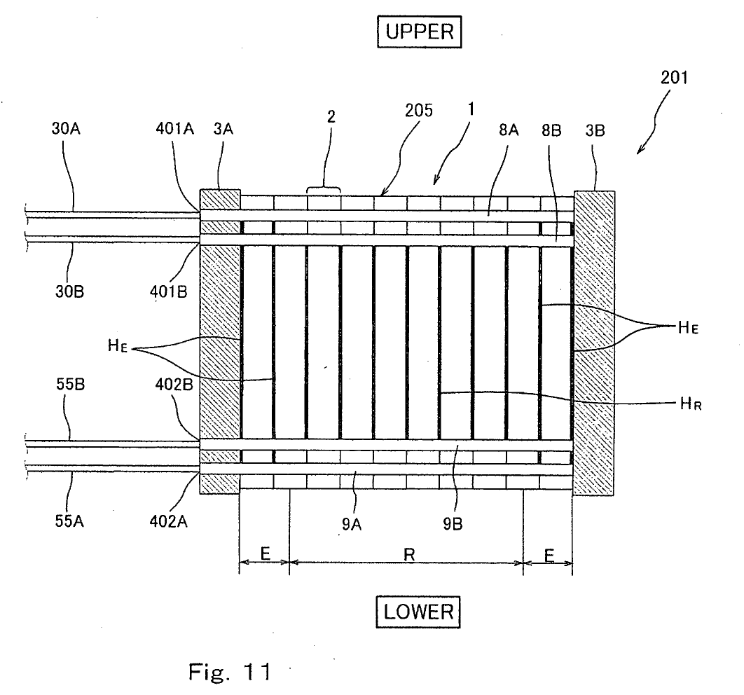

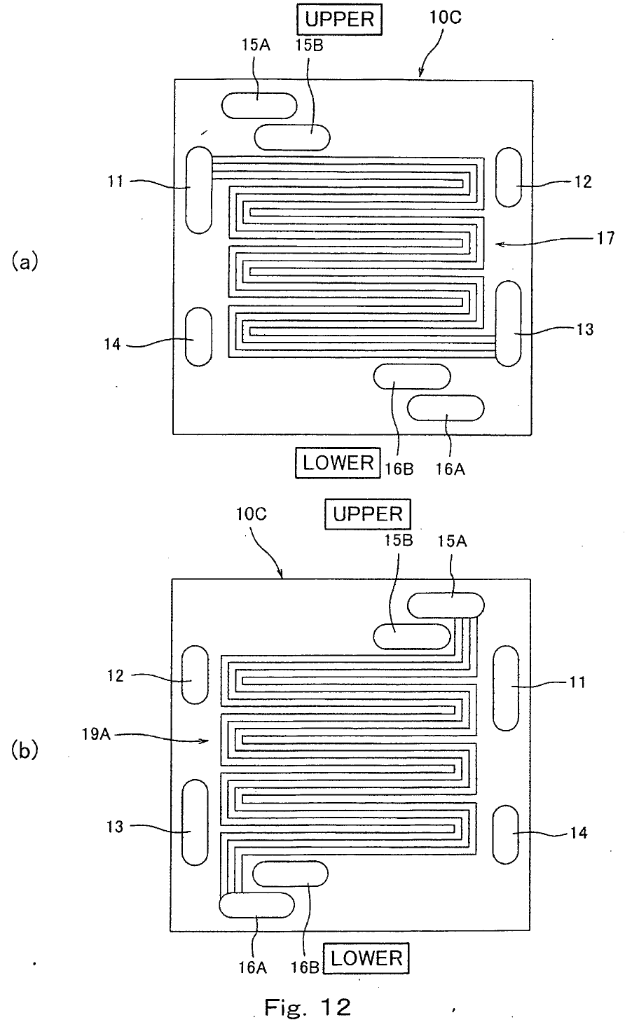

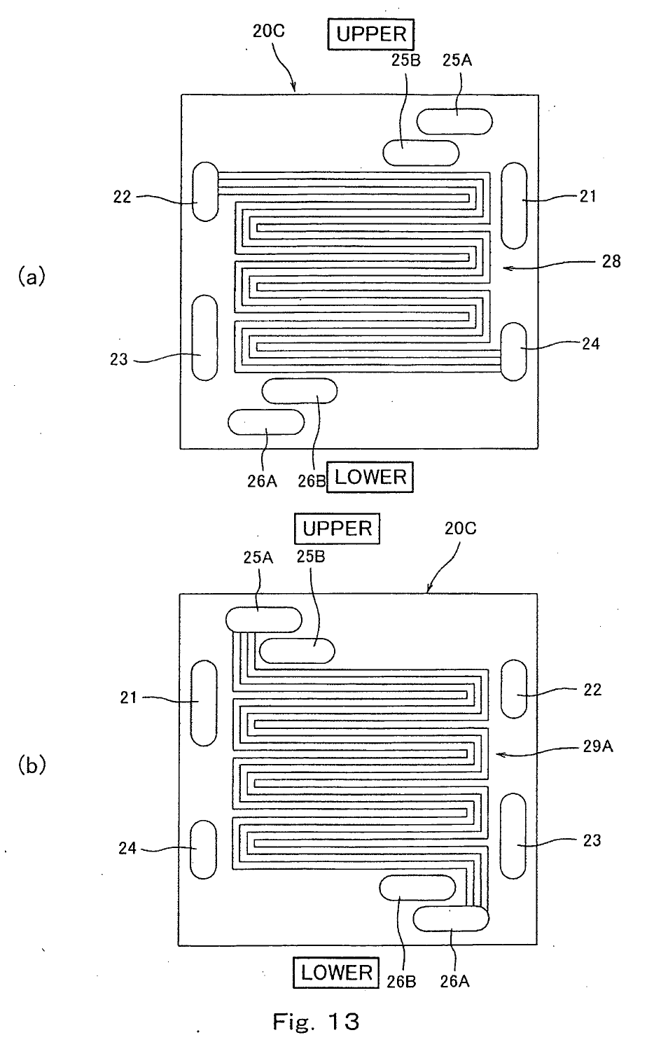

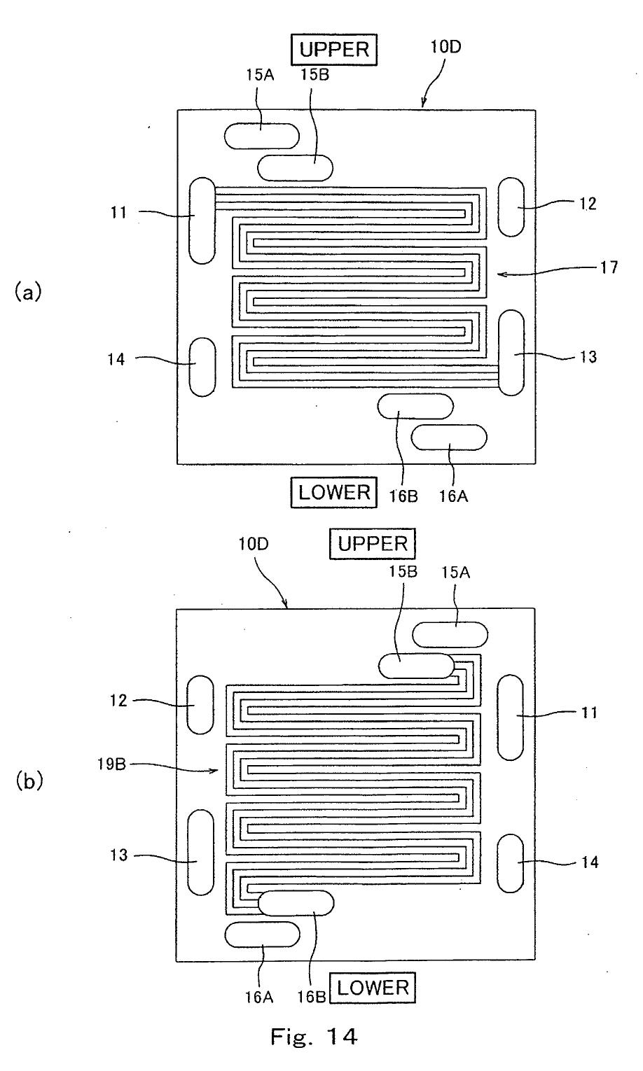

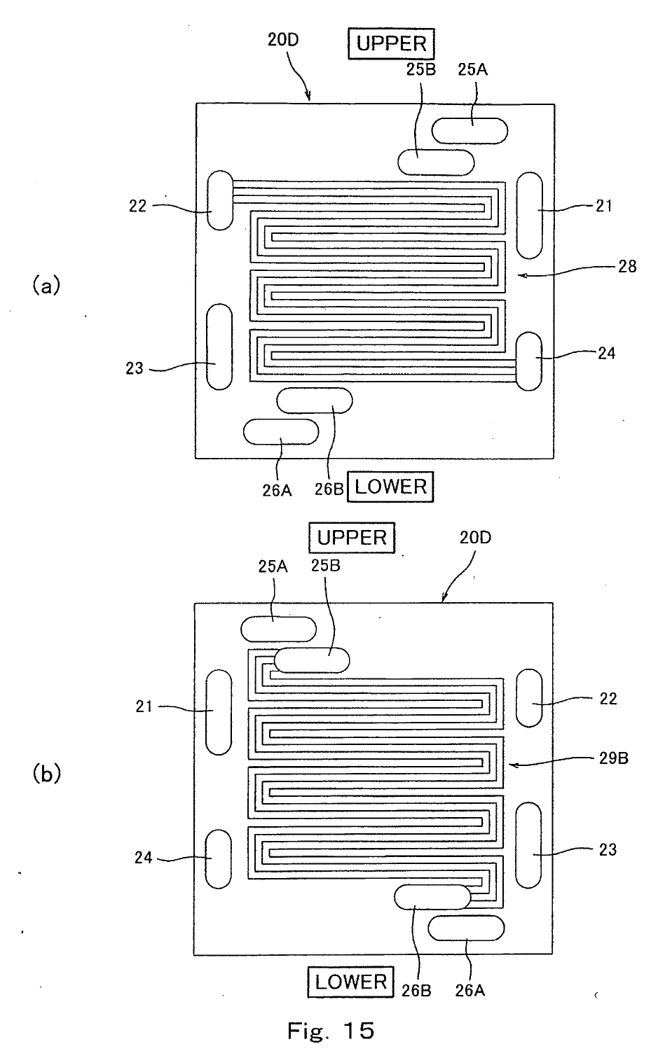

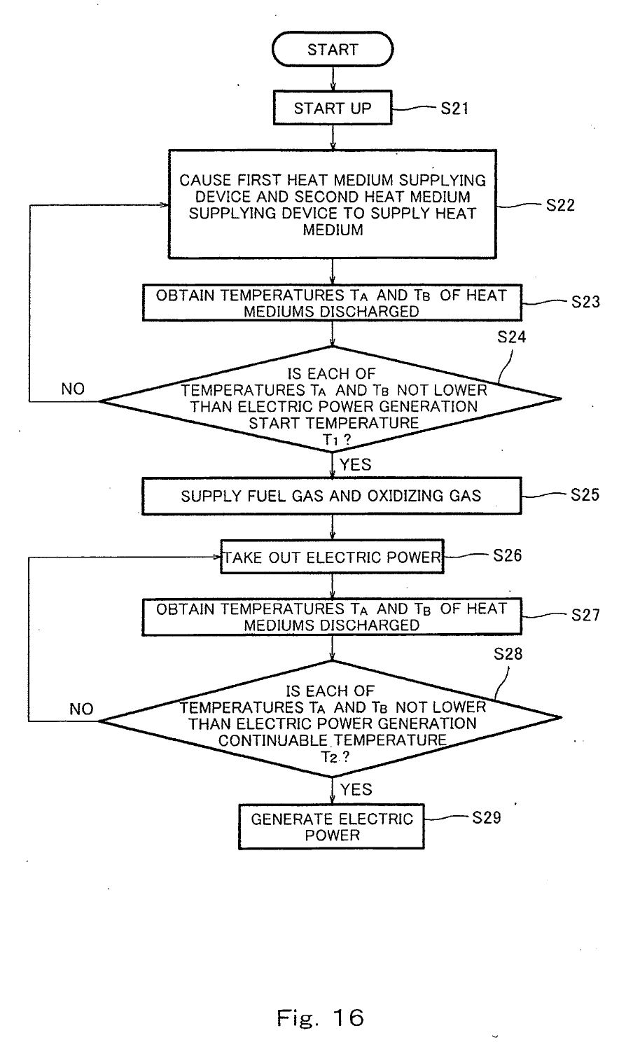

FIG. 10 is a block diagram showing a schematic configuration of the fuel cell system of Embodiment 2 of the present invention. FIG. 11 is a schematic diagram showing the configuration of the fuel cell for use in the fuel cell system of FIG. 10. FIG. 12 are plan views showing the configurations of both main surfaces of the end portion cathode separator for use in the fuel cell of FIG. 11. FIG. 12(a) is a plan view showing the main surface on which the oxidizing gas channel is formed. FIG. 12(b) is a diagram showing a surface opposite to the surface of FIG. 12(a) and is a plan view showing the main surface on which the heat medium channel is formed. FIG. 13 are plan views showing the configurations of both main surfaces of the end portion anode separator for use in the fuel cell of FIG. 11. FIG. 13(a) is a plan view showing the main surface on which the fuel gas channel is formed. FIG. 13(b) is a diagram showing a surface opposite to the surface of FIG. 13(a) and is a plan view showing the main surface on which the heat medium channel is formed. FIG. 14 are plan views showing the configurations of both main surfaces of the remaining portion cathode separator for use in the fuel cell of FIG. 11. FIG. 14(a) is a plan view showing the main surface on which the oxidizing gas channel is formed. FIG. 14(b) is a diagram showing a surface opposite to the surface of FIG. 14(a) and is a plan view showing the main surface on which the heat medium channel is formed. FIG. 15 are plan views showing the configurations of both main surfaces of the remaining portion anode separator for use in the fuel cell of FIG. 11. FIG. 15(a) is a plan view showing the main surface on which the fuel gas channel is formed. FIG. 15(b) is a diagram showing a surface opposite to the surface of FIG. 15(a) and is a plan view showing the main surface on which the heat medium channel is formed. FIG. 16 is a flow chart showing a control program for controlling the fuel cell system of FIG. 10. Hereinafter, the fuel cell system of the present embodiment will be explained in reference to FIGS. 10 to 16.

In a fuel cell system 200 of the present embodiment, a heat medium flow passage (first heat medium flow passage) through which the heat medium is supplied to the heat transferring portions H_{E} of both end portions E of the cell stack 1 and a heat medium flow passage (second heat medium flow passage) through which the heat medium is supplied to the heat transferring portions H_{R} of the remaining portion R that is a portion other than the end portions of the cell stack 1 are separately formed (see FIG. 10). Further, the fuel cell system 200 of the present embodiment uses a fuel cell 201 which is different in configuration from the fuel cell 101 used in Embodiment 1. Other than this, the fuel cell system 200 of the present embodiment uses the same components as the fuel cell system 100 of Embodiment 1. Therefore, in FIGS. 10 to 15, same reference numbers are used for the same or corresponding components as in FIGS. 1, 2, and 5 to 8, and a repetition of the same explanation is avoided.

As shown in FIG. 10, in the fuel cell system 200 of the present embodiment, a first heat medium flow passage 113A and a second heat medium flow passage 113B are formed so as to pass through the fuel cell 201.

The first heat medium flow passage 113A is constituted by a first internal heat medium flow passage (not shown) formed inside the fuel cell 201 and a first external heat medium flow passage 112A (30A, 55A) for supplying the heat medium to the first internal heat medium flow passage. The first internal heat medium flow passage is constituted by the first heat medium supply manifold 8A, first heat medium channels 19A and 29A, and a first heat medium discharge sub-manifold 9A, which will be described later. The first external heat medium flow passage 112A is connected to the first heat medium entrance 401A and a first heat medium exit 402A. A first heat medium supplying device 120A and a first temperature detector 140A are disposed on the first external heat medium flow passage 112A. The first heat medium supplying device 120A supplies the heat medium through the first external heat medium flow passage 112A and the first heat medium entrance 401A to the fuel cell 201. The heat medium having been supplied to the fuel cell 201 flows through the fuel cell 201, and then is discharged from the first heat medium exit 402A. The discharged heat medium returns through the first external heat medium flow passage 112A (first heat medium discharge pipe 55A) to the first heat medium supplying device 120A. The first heat medium supplying device 120A includes a temperature adjuster, not shown, and adjusts to a predetermined temperature the temperature of the heat medium having flowed through and returned from the fuel cell 201. The temperature adjuster, not shown, includes, for example, a heater that is a portion functioning to heat the heat medium, and a radiator that is a portion functioning to cool down the heat medium. Moreover, the first heat medium supplying device 120A includes a pump, not shown, and starts and stops the flow of the heat medium and adjusts the flow rate of the heat medium. The first temperature detector 140A is disposed on the first external heat medium flow passage 112A in the vicinity of the first heat medium exit 402A, and detects the temperature of the heat medium having flowed through the fuel cell 201 and having been discharged from the first heat medium exit 402A.

Meanwhile, the second heat medium flow passage 113B is constituted by a second internal heat medium flow passage (not shown) formed inside the fuel cell 201 and a second external heat medium flow passage 112B (30B, 55B) for supplying the heat medium to the second internal heat medium flow passage. The second internal heat medium flow passage is constituted by the second heat medium supply manifold 8B, second heat medium channels 19B and 29B, and a second heat medium discharge sub-manifold 9B, which will be described later. The second external heat medium flow passage 112B is connected to the second heat medium entrance 401B and a second heat medium exit 402B. A second heat medium supplying device 120B and a second temperature detector 140B are disposed on the second external heat medium flow passage 112B. The second heat medium supplying device 120B supplies the heat medium through the second external heat medium flow passage 112B and the second heat medium entrance 401B to the fuel cell 201. The heat medium having been supplied through the second heat medium entrance 401B to the fuel cell 201 flows through the fuel cell 201, and then is discharged from the second heat medium exit 402B. The discharged heat medium returns through the second external heat medium flow passage 112B (second the heat medium discharge pipe 55B) to the second heat medium supplying device 120B. The second heat medium supplying device 120B includes a temperature adjuster, not shown, and adjusts to a predetermined temperature the temperature of the heat medium having flowed through and returned from the fuel cell 201. The temperature adjuster, not shown, includes, for example, a heater that is a portion functioning to heat the heat medium, and a radiator that is a portion functioning to cool down the heat medium. Moreover, the second heat medium supplying device 120B includes a pump, not shown, and starts and stops the flow of the heat medium and adjusts the flow rate of the heat medium. The second temperature detector 140B is disposed on the second external heat medium flow passage 112B in the vicinity of the second heat medium exit 402B, and detects the temperature of the heat medium having flowed through the fuel cell 201 and having been discharged from the second heat medium exit 402B.

Next, the fuel cell 201 used in the fuel cell system 200 of the present embodiment will be explained.

As shown in FIG. 11, the cell stack 1 is divided into the end portions E that are both end portions in the stack direction of the cell 2, and the remaining portion R that is a portion other than the end portions E. Only the configurations of the separators constituting the cell 2 are slightly different between the end portion E and the remaining portion R. Therefore, hereinafter, the configurations of common components therebetween will be explained without distinction. In addition, explanations of the common components with the fuel cell 101 used in Embodiment 1 will be omitted.

The fuel cell 201 includes the first heat medium supply manifold 8A, the second heat medium supply manifold 8B, the first heat medium discharge sub-manifold 9A, and the second heat medium discharge sub-manifold 9B, which extend in the stack direction of the cells 2 of the cell stack 1. In FIG. 11, the fuel gas supply manifold, the fuel gas discharge manifold, the oxidizing gas supply manifold, and the oxidizing gas discharge manifold are not shown. Moreover, the components other than the first heat medium discharge sub-manifold 9A and the second heat medium discharge sub-manifold 9B, which will be described later, are configured in the same manner as those of the fuel cell 101 used in the fuel cell system 100 Embodiment 1.

The first heat medium discharge sub-manifold 9A is connected to the heat transferring portions H_{E} formed at both end portions E of the cell stack 1. The heat medium having flowed through the heat transferring portions H_{E} formed at both end portions E of the cell stack 1 flows through the first heat medium discharge sub-manifold 9A. The heat medium having flowed through the first heat medium discharge sub-manifold 9A is discharged from the first heat medium exit 402A of the fuel cell 201, and returns through the first external heat medium flow passage 112A to the first heat medium supplying device 120A.

Meanwhile, the second heat medium discharge sub-manifold 9B is formed below the first heat medium discharge sub-manifold 9A. The second heat medium discharge sub-manifold 9B is connected to the heat transferring portions H_{R} formed at the remaining portion R of the cell stack 1. The heat medium having flowed through the heat transferring portions H_{R} formed at the remaining portion R of the cell stack 1 flows through the second heat medium discharge sub-manifold 9B. The heat medium having flowed through the second heat medium discharge sub-manifold 9B is discharged from the second heat medium exit 402B of the fuel cell 201, and returns through the second external heat medium flow passage 112B to the second heat medium supplying device 120B.

Next, the separators constituting the cell stack 1 will be explained. Herein, the separators are an end portion cathode separator 10C, an end portion anode separator 20C, a remaining portion cathode separator 10D, and a remaining portion anode separator 20D. Hereinafter, these separators will be explained.

As shown in FIG. 12, in the end portion cathode separator 10C, the heat medium discharge manifold hole is constituted by a first heat medium discharge sub-manifold hole 16A and a second heat medium discharge sub-manifold hole 16B. The first heat medium discharge sub-manifold hole 16A is formed below and inwardly of the oxidizing gas discharge manifold hole 13. The second heat medium discharge sub-manifold 16B is formed below and inwardly of the oxidizing gas discharge manifold hole 13 and above the first heat medium discharge sub-manifold hole 16A. As shown in FIG. 12(b), a first heat medium channel 19A is formed on one main surface of the end portion cathode separator 10C so as to connect the first heat medium supply manifold hole 15A and the first heat medium discharge sub-manifold hole 16A. Other than this, the end portion cathode separator 10C is configured in the same manner as the end portion cathode separator 10A shown in FIG. 5.

As shown in FIG. 13, in the end portion anode separator 20C, the heat medium discharge manifold hole is constituted by a first heat medium discharge sub-manifold hole 26A and a second heat medium discharge sub-manifold hole 26B. The first heat medium discharge sub-manifold hole 26A is formed below and inwardly of the oxidizing gas discharge manifold hole 23. The second heat medium discharge sub-manifold 26B is formed below and inwardly of the oxidizing gas discharge manifold hole 23 and above the first heat medium discharge sub-manifold hole 26A. As shown in FIG. 13(b), the first heat medium channel 29A is formed on one main surface of the end portion anode separator 20C so as to connect the first heat medium supply manifold hole 25A and the first heat medium discharge sub-manifold hole 26A. Other than this, the end portion anode separator 20C is configured in the same manner as the end portion anode separator 20A shown in FIG. 6.

As shown in FIG. 14 (especially see FIG. 14(b)), an upstream end of the second heat medium channel 19B formed on a rear surface of the remaining portion cathode separator 10D is connected not to the first heat medium supply manifold hole 15A but to the second heat medium supply manifold hole 15B. In addition, a downstream end of the second heat medium channel 19B is connected not to the first heat medium discharge sub-manifold hole 16A but to the second heat medium discharge sub-manifold hole 16B. Other than this, the remaining portion cathode separator 10D is configured in the same manner as the end portion cathode separator 10C shown in FIG. 12.

As shown in FIG. 15 (especially see FIG. 15(b)), an upstream end of the second heat medium channel 29B formed on a rear surface of the remaining portion anode separator 20D is connected not to the first heat medium supply manifold hole 25A but to the second heat medium supply manifold hole 25B. In addition, a downstream end of the second heat medium channel 29B is connected not to the first heat medium discharge sub-manifold hole 26A but to the second heat medium discharge sub-manifold hole 26B. Other than this, the remaining portion anode separator 20D is configured in the same manner as the end portion anode separator 20C shown in FIG. 13.

Then, the first heat medium discharge sub-manifold holes 16A and 26A of respective separators constitute a part of the first heat medium discharge sub-manifold 9A. The second heat medium discharge sub-manifold holes 16B and 26B of respective separators constitute a part of the second heat medium discharge sub-manifold 9B.

Next, the configurations of both end portions E and the remaining portion R of the cell stack 1 will be explained (see FIG. 11).

At the end portion E, the end portion cathode separator 10C and the end portion anode separator 20C sandwich the MEA member 43 to form a reacting portion and a heat transferring portion. At the remaining portion R, the reacting portion and the heat transferring portion are formed as below. To be specific, at a portion of the remaining portion R which portion is adjacent to one end portion E, the end portion cathode separator 10C and the remaining portion anode separator 20D sandwich the MEA member 43 to form the reacting portion, and at a portion of the remaining portion R which portion is adjacent to the other end portion E, the end portion anode separator 20C and the remaining portion cathode separator 10D sandwich the MEA member 43 to form the reacting portion. At a portion of the remaining portion R other than the above portions, the remaining portion cathode separator 10D and the remaining portion anode separator 20D sandwich the MEA member 43 to form the reacting portion and the heat transferring portion. A portion from the cathode gas channel 17 formed on the end portion cathode separator 10C to the anode gas channel 28 formed on the end portion anode separator 20C constitutes the reacting portion of each of both end portions E of the cell stack 1. Each of a portion where the first heat medium channel 19A formed on the end portion cathode separator 10C and any end plate contacts each other, a portion where the first heat medium channel 29A formed on the end portion anode separator 20C and any end plate contact each other, and a portion where the first heat medium channel 19A formed on the end portion cathode separator 10C and the first heat medium channel 29A formed on the end portion anode separator 20C contact each other constitutes the heat transferring portion H_{E} at the end portion E of the cell stack 1. In the present embodiment, the number of heat transferring portions H_{E} at each of both end portions E of the cell stack 1 is two.

Moreover, a portion from the cathode gas channel 17 formed on the remaining portion cathode separator 10D to the anode gas channel 28 formed on the remaining portion anode separator 20D constitutes the reacting portion of the remaining portion R of the cell stack 1. A portion where the second heat medium channel 19B formed on the remaining portion cathode separator 10D and the second heat medium channel 29B formed on the remaining portion anode separator 20D contacts each other constitutes the heat transferring portion H_{R} of the remaining portion R of the cell stack 1.

In the fuel cell 201 configured as above, the heat medium flows as follows. Note that the flow of the fuel gas and the flow of the oxidizing gas are the same as those of the fuel cell 101 used in the fuel cell system 100 of Embodiment 1.

The first heat medium supplying device 120A supplies the heat medium through the first external heat medium flow passage 112A (first heat medium supply pipe 30A) and the first heat medium entrance 401A to the first heat medium supply manifold 8A of the cell stack 1. The heat medium having been supplied to the first heat medium supply manifold 8A flows from the first heat medium supply manifold 8A to the first heat medium supply manifold holes 15A and 25A of each cell 2 of the end portion E, and flows through the heat transferring portion H_{E} (first heat medium channels 19A and 29A) of the end portion E. In this period, the heat medium exchanges heat with the cathode and the anode of the end portion E via the end portion cathode separator 10C and the end portion anode separator 20C, and flows out from the first heat medium discharge sub-manifold holes 16A and 26A to the first heat medium discharge sub-manifold 9A. Then, the heat medium is discharged from the first heat medium exit 402A through the first external heat medium flow passage 112A (first heat medium discharge pipe 55A) to the outside of the cell stack 1.

Meanwhile, the second heat medium supplying device 120B supplies the heat medium through the second heat medium flow passage 112B (second heat medium supply pipe 30B) and the second heat medium entrance 401B to the second heat medium supply manifold 8B of the cell stack 1. The heat medium having been supplied to the second heat medium supply manifold 8B flows from the second heat medium supply manifold 8B to the second heat medium supply manifold holes 15B and 25B of each cell 2 of the remaining portion R, and flows through the heat transferring portion H_{R} (second heat medium channels 19B and 29B) of the remaining portion R. In this period, the heat medium exchanges heat with the cathode and the anode of the remaining portion R via the remaining portion cathode separator 10D and the remaining portion anode separator 20D, and flows out from the second heat medium discharge sub-manifold holes 16B and 26B to the second heat medium discharge sub-manifold 9B. Then, the heat medium is discharged from the second heat medium exit 402B through the second external heat medium flow passage 112B (second heat medium discharge pipe 55B) to the outside of the cell stack 1.

Next, operations of the fuel cell system 200 of the present embodiment will be explained. The fuel cell system 200 has the electric power generating mode in which the fuel cell system 200 generates the electric power by the fuel cell 201 and supplies the electric power to the external load, and the start-up mode in which the fuel cell system 200 shifts from the stop state to the electric power generating mode. Hereinafter, these modes of the fuel cell system 200 will be explained. Note that the following operations of the fuel cell system 200 will be realized by the controller 160. Specifically, the following operations of the fuel cell system 200 will be realized by the calculating portion 162 of the controller 160 which executes the control program stored in the storage portion 161 of the controller 160.

As shown in FIG. 16, the controller 160 starts up the fuel cell system 200 (Step S21). Next, the controller 160 causes the first heat medium supplying device 120A and the second heat medium supplying device 120B to start supplying the heat medium (Step S22). With this, the heat medium flows through the first heat medium supply manifold 8A to the heat transferring portion H_{E} of the end portion E of the cell stack 1, and is discharged through the first heat medium discharge sub-manifold 9A to the outside of the cell stack 1. In addition, the heat medium flows through the second heat medium supply manifold 8B to the heat transferring portion H_{R} of the remaining portion R of the cell stack 1, and is discharged through the second heat medium discharge sub-manifold 9B to the outside of the cell stack 1. As above, by causing the heat medium to flow through the heat transferring portion H_{E} of the end portion E and the heat transferring portion H_{R} of the remaining portion R, the entire cell stack 1 is quickly warmed up. In the present embodiment, the temperature of the heat medium supplied from the first heat medium supplying device 120A to the end portion E is set to 65° C., and the temperature of the heat medium supplied from the second heat medium supplying device 120B to the remaining portion R is set to 60° C. As above, it is preferable that the temperature of the heat medium supplied from the first heat medium supplying device 120A to the end portion E be set to be higher than the temperature of the heat medium supplied from the second heat medium supplying device 120B to the remaining portion R, since this makes it possible to quickly warm up the end portion E which releases much heat.

Next, the controller 160 obtains by the first temperature detector 140A a temperature T_{A} of the heat medium discharged from the first heat medium discharge sub-manifold 9A, and obtains by the second temperature detector 140B a temperature T_{B} of the heat medium discharged from the second heat medium discharge sub-manifold 9B (Step S23). The controller 160 determines whether or not each of the obtained temperatures T_{A} and T_{B} of the heat medium is not lower than the electric power generation start temperature T₁ (Step S24). In a case where any one of the obtained temperatures T_{A} and T_{B} of the heat medium is lower than the electric power generation start temperature T₁, the controller 160 repeats Steps S22 to S24 until each of the temperatures T_{A} and T_{B} of the heat medium becomes the electric power generation start temperature T₁, or higher. In the present embodiment, the electric power generation start temperature T₁, is set to 55° C. It is preferable that the electric power generation start temperature T₁, be set in a range of 50° C. to 55° C.

Meanwhile, in a case where each of the obtained temperatures T_{A} and T_{B} of the heat medium is the electric power generation start temperature T₁, or higher in Step S24, the controller 160 causes the fuel gas supplying device 102 to supply the fuel gas to the anode of the fuel cell 201 and causes the oxidizing gas supplying device 103 to supply the oxidizing gas to the cathode of the fuel cell 201 (Step S25).

Next, the controller 160 takes out the electric power from the fuel cell 201 by the inverter 150 (Step S26). With this, the chemical reaction between the fuel gas and the oxidizing gas generates the reaction heat. The temperature of the cell stack 1 increases by the reaction heat.

Then, the controller 160 obtains by the first temperature detector 140A the temperature T_{A} of the heat medium discharged from the first heat medium discharge sub-manifold 9A, and obtains by the second temperature detector 140B the temperature T_{B} of the heat medium discharged from the second heat medium discharge sub-manifold 9B (Step S27). Then, the controller 160 determines whether or not each of the obtained temperatures T_{A} and T_{B} of the heat medium is not lower than the electric power generation continuable temperature T₂ (Step S28). In a case where any one of the obtained temperatures T_{A} and T_{B} of the heat medium is lower than the electric power generation continuable temperature T₂, the controller 160 continues to take out the electric power from the fuel cell 201 (Step S26), and repeats Steps S26 to S28 until each of the obtained temperatures T_{A} and T_{B} of the heat medium becomes the electric power generation continuable temperature T₂ or higher. Here, the electric power generation continuable temperature T₂ is higher than the electric power generation start temperature T₁, and is set to 65° C. in the present embodiment. It is preferable that the electric power generation continuable temperature T₂ be set in a range of 65° C. to 70° C.

In a case where each of the obtained temperatures T_{A} and T_{B} of the heat medium is the electric power generation continuable temperature T₂ or higher in Step S28, the fuel cell system 200 terminates the start-up mode (Step S28), and shifts to the electric power generating mode to generate the electric power by the fuel cell 201 (Step S29).

In this state, since the temperature of the cell stack 1 is higher than the temperature (65° C.) of the heat medium supplied from the first heat medium supplying device 120A and the temperature (60° C.) of the heat medium supplied from the second heat medium supplying device 120B, the end portions E and the remaining portion R are cooled down by the heat medium flowing through the end portions E and the remaining portion R of the cell stack 1.

Since the fuel cell system 200 of the present embodiment is configured as above, the heat medium can be separately supplied through the first heat medium flow passage 113A and the second heat medium flow passage 113B. Therefore, the heat medium supplied to the first heat medium flow passage 113A and the heat medium supplied to the second heat medium flow passage 113B can be made different in temperature from each other. For example, it is possible to quickly increase the temperature of the end portion E of the cell stack 1 in the start-up mode of the fuel cell system 200 by supplying the high-temperature heat medium to the heat transferring portion H_{E} of the end portion E which releases much heat, and it is also possible to maintain the end portion E at an appropriate temperature at the time of the electric power generation by not cooling down too much.

### Modification Example

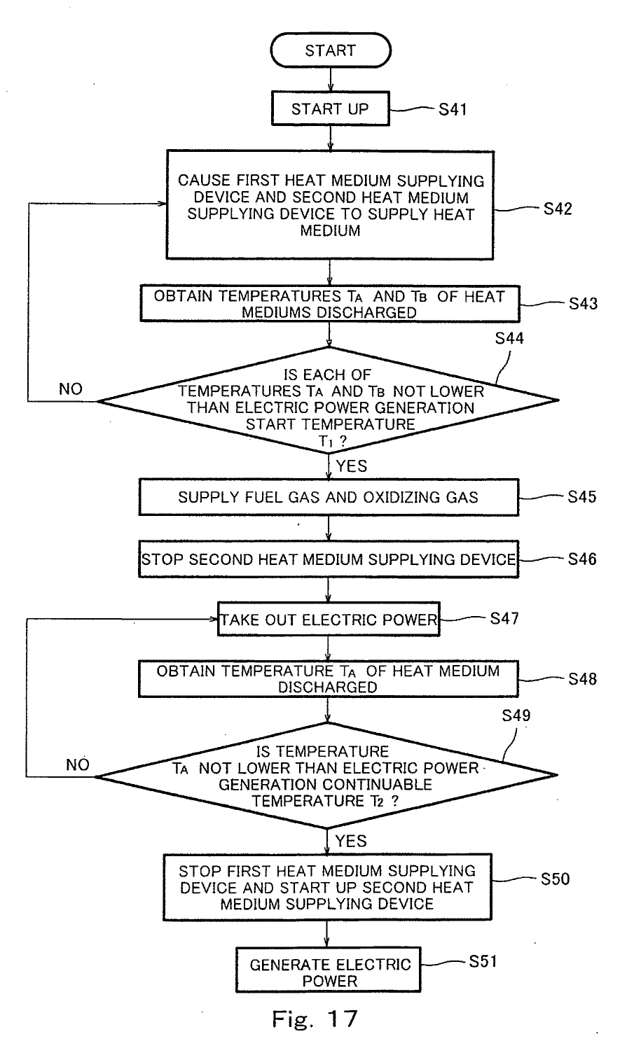

FIG. 17 is a diagram showing Modification Example of Embodiment 2 and is a flow chart showing a control program for controlling the fuel cell system of FIG. 10. To be specific, in Modification Example, the fuel cell system 200 of Embodiment 2 is used, and the control program for controlling the fuel cell system 200 is changed.

As shown in FIG. 17, Steps S41 to S45 are the same as Steps S21 to S25 of the control program for controlling the fuel cell system 200 of Embodiment 2. Therefore, hereinafter, Step S46 and the following steps will be explained.

The controller 160 causes the fuel gas supplying device 102 to supply the fuel gas to the anode of the fuel cell 201, and causes the oxidizing gas supplying device 103 to supply the oxidizing gas to the cathode of the fuel cell 201 (Step S45). Then, the controller 160 causes the second heat medium supplying device 120B to stop supplying the heat medium to the remaining portion R (Step S46). With this, although the supply of the heat medium from the second heat medium supplying device 120B to the heat transferring portion H_{R} of the remaining portion R stops, the supply of the heat medium from the first heat medium supplying device 120A to the heat transferring portion H_{E} of the end portion E continues.

Then, the controller 160 takes out the electric power from the fuel cell 201 by the inverter 150 (Step S47). With this, the chemical reaction between the fuel gas and the oxidizing gas generates the reaction heat. The temperature of the cell stack 1 increases by the reaction heat. At this time, if the heat medium continues to be supplied to both the heat transferring portion H_{R} of the remaining portion R and the heat transferring portion H_{E} of the end portion E, the remaining portion R slightly increases in temperature since the remaining portion R does not release heat, although the heat medium supplied to the heat transferring portion H_{R} of the remaining portion R is lower in temperature than the heat medium supplied to the heat transferring portion H_{E} of the end portion E. Thus, the remaining portion R and the end portion E increase in temperature slightly nonuniformly. However, in Modification Example, since the supply of the heat medium to the heat transferring portion H_{R} of the remaining portion R is stopped at this time, the remaining portion R and the end portion E increase in temperature uniformly.

Then, the controller 160 obtains by the first temperature detector 140A the temperature T_{A} of the heat medium discharged from the first heat medium discharge sub-manifold 9A (Step S48). Then, the controller 160 determines whether or not the obtained temperature T_{A} of the heat medium is not lower than the electric power generation continuable temperature T₂ (Step S49). In a case where the obtained temperature T_{A} of the heat medium is lower than the electric power generation continuable temperature T₂, the controller 160 continues to take out the electric power from the fuel cell 201 (Step S47), and repeats Steps S47 to S49 until the obtained temperature T_{A} of the heat medium becomes the electric power generation continuable temperature T₂ or higher. Here, the electric power generation continuable temperature T₂ is higher than the electric power generation start temperature T₁, and is set to 65° C. in the present embodiment. In Modification Example, it is preferable that the electric power generation continuable temperature T₂ be set in a range of 65° C. to 70° C.

In a case where the obtained temperature T_{A} of the heat medium is the electric power generation continuable temperature T₂ or higher in Step S49, the controller 160 causes the first heat medium supplying device 120A to stop supplying the heat medium, and causes the second heat medium supplying device 120B to start supplying the heat medium (Step S50). With this, the fuel cell system 200 terminates the start-up mode (Step S50), and shifts to the electric power generating mode to generate the electric power by the fuel cell 201 (Step S51). In this state, since the temperature of the cell stack 1 is higher than the temperature (60° C.) of the heat medium supplied from the second heat medium supplying device 120B, the remaining portion R is cooled down by the heat medium flowing through the remaining portion R of the cell stack 1. Meanwhile, since the flow of the heat medium to the end portion E of the cell stack 1 is stopped, the end portion E is cooled down not by the heat medium but by the heat release only. As a result, the remaining portion R is cooled down by the heat medium to a required level, and the end portion E becomes a substantially appropriate temperature by the heat release. With this, the electric power generation is stably carried out by the fuel cell 201.

In Modification Example, in the start-up mode of the fuel cell system 200, by not supplying the heat medium to the heat transferring portion H_{E} of the end portion E which releases much heat, the end portion E of the cell stack 1 is prevented from exchanging heat with the heat medium. Thus, a temperature decrease of the end portion E of the cell stack 1 is suppressed. Meanwhile, in the electric power generating mode of the fuel cell system 200, by supplying the heat medium to the heat transferring portion H_{R} of the remaining portion R of the cell stack 1, the remaining portion R is cooled down to a required level. Therefore, the temperatures of the end portions E and the remaining portion R of the cell stack 1 can be controlled in both the start-up mode and the electric power generating mode. With this, the quick start-up and stable electric power generation of the fuel cell system 200 are realized.

In Modification Example, in the start-up mode of the fuel cell system 200, the controller 160 causes the first heat medium supplying device 120A and the second heat medium supplying device 120B to stop supplying the heat medium. However, the controller 160 may cause the first heat medium supplying device 120A and the second heat medium supplying device 120B to increase and decrease the amount of heat medium supplied. With this configuration, the amount of heat medium supplied to the heat transferring portions H_{E} and H_{R} can be changed in accordance with the temperatures of the end portions E and the remaining portion R of the cell stack 1. Therefore, it is possible to flexibly control the temperatures of the end portions E and the remaining portion R.

### Embodiment 3

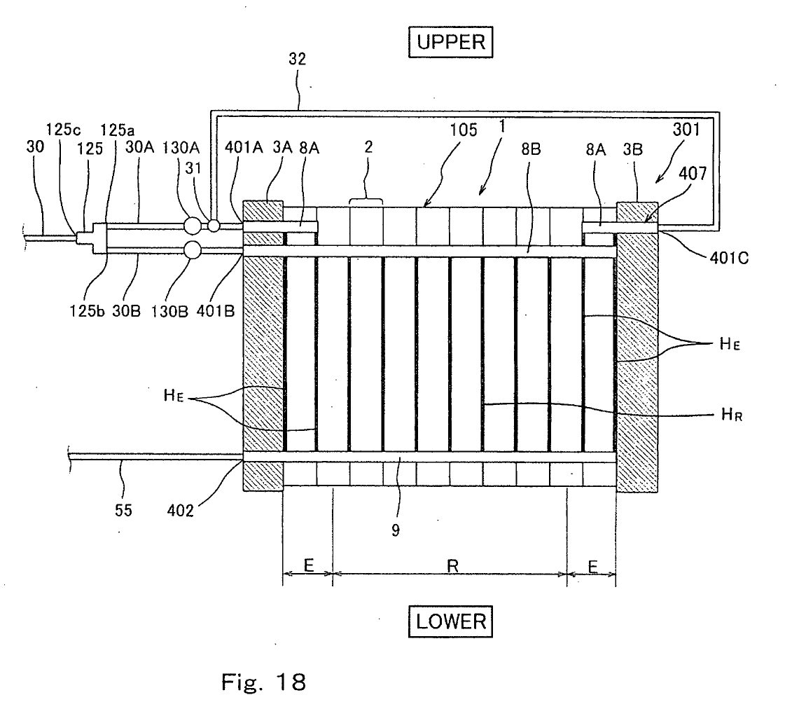

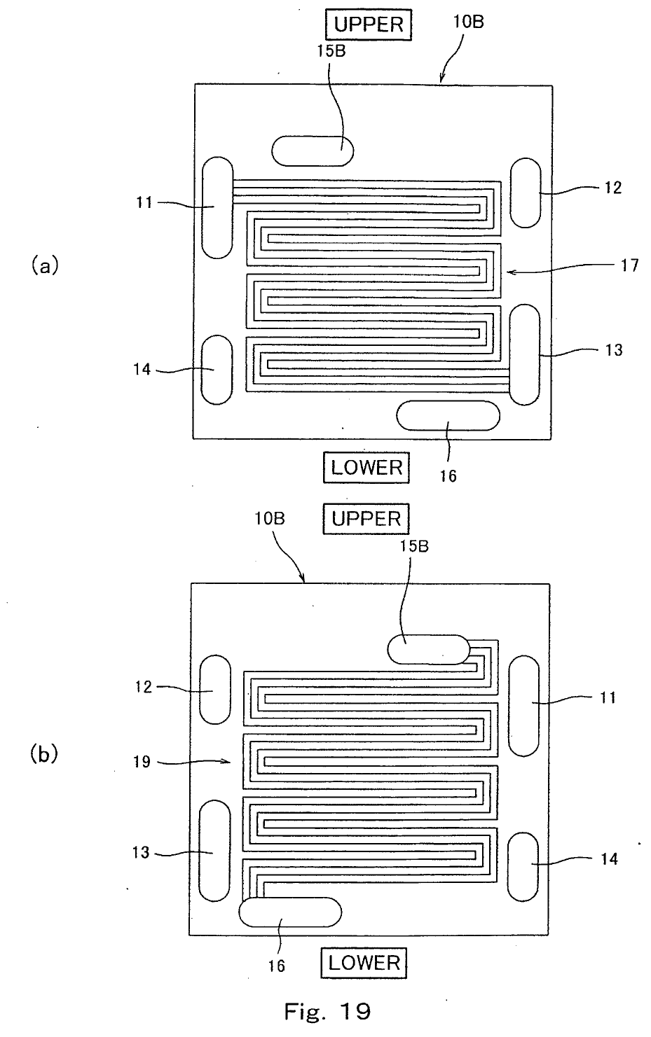

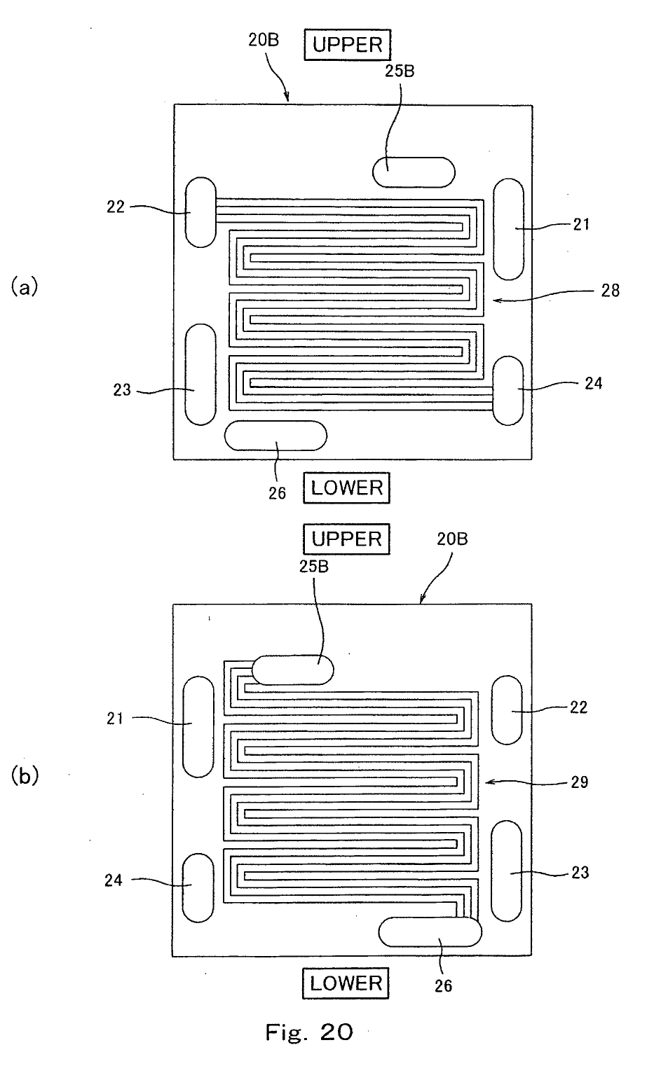

FIG. 18 is a schematic diagram showing the configuration of the fuel cell for use in the fuel cell system of Embodiment 3 of the present invention. FIG. 19 are plan views showing the configurations of both main surfaces of the remaining portion cathode separator for use in the fuel cell of FIG. 18. FIG. 19(a) is a plan view showing the main surface on which the oxidizing gas channel is formed. FIG. 19(b) is a diagram showing a surface opposite to the surface of FIG. 19(a) and is a plan view showing the main surface on which the heat medium channel is formed. FIG. 20 are plan views showing the configurations of both main surfaces of the remaining portion anode separator for use in the fuel cell of FIG. 18. FIG. 20(a) is a plan view showing the main surface on which the fuel gas channel is formed. FIG. 20(b) is a diagram showing a surface opposite to the surface of FIG. 20(a) and is a plan view showing the main surface on which the heat medium channel is formed. Hereinafter, the fuel cell and the fuel cell system according to Embodiment 3 will be explained in reference to FIGS. 18 to 20.

As shown in FIG. 18, a fuel cell 301 of Embodiment 3 is configured such that the configuration of the cell stack 1 of the fuel cell of Embodiment 1 (FIG. 1) is changed. Specifically, as will be described later, the configurations of the remaining portion cathode separator and the remaining portion anode separator are changed. Moreover, a through hole 407 is formed on the second end plate 3B, and an opening formed outwardly of the through hole 407 constitutes a third heat medium entrance 401C. Further, a branched portion 31 is formed on a portion of the first heat medium supply pipe 30A, and a third heat medium supply pipe 32 is connected to the branched portion 31. Hereinafter, these changes will be explained in detail.

As shown in FIG. 19, the first heat medium supply manifold hole 15A is not formed on the remaining portion cathode separator 10B used in the present embodiment. Other than this, the remaining portion cathode separator 10B is configured in the same manner as the remaining portion cathode separator shown in FIG. 7. Moreover, as shown in FIG. 20, the first heat medium supply manifold hole 25A is not formed on the remaining portion anode separator 20B used in the present embodiment. Other than this, the remaining portion anode separator 20B is configured in the same manner as the remaining portion anode separator shown in FIG. 8. Meanwhile, the configurations of the end portion cathode separator 10A and the end portion anode separator are the same as those (the end portion cathode separator shown in FIG. 5 and the end portion anode separator shown in FIG. 6) used in Embodiment 1. With this configuration, as shown in FIG. 18, the first heat medium supply manifold 8A is formed only at each of the end portions E of the cell stack 1, and is not formed at the remaining portion R of the cell stack 1. To be specific, the first heat medium supply manifold 8A is formed so as not to penetrate through the entire cell stack body 105 in the stack direction.

The through hole 407 is formed on a portion of the second end plate 3B which portion corresponds to a position where the first heat medium supply manifold 8A is formed. With this, the first heat medium supply manifold 8A formed on the other end portion E is communicated with the through hole 407.

The branched portion 31 is formed downstream of a portion of the first heat medium supply pipe 30A on which portion the first on-off valve 30A is disposed. An upstream end of the third heat medium supply pipe 32 is connected to the branched portion 31.

Then, a downstream end of the first heat medium supply pipe 30A is connected to the first heat medium entrance 401A through which the heat medium is supplied to one of the end portions E of the cell stack 1, and a downstream end of the third heat medium supply pipe 32 is connected to the third heat medium entrance 401C through which the heat medium is supplied to the other end portion E of the cell stack 1. With this, the heat medium flows to the heat transferring portion H_{E} of the end portion E through the first heat medium supply manifold 8A formed only at each of the end portions E of the cell stack 1. Other than this, the fuel cell 301 of Embodiment 3 is configured in the same manner as the fuel cell of Embodiment 1.

The fuel cell 301 and the fuel cell system according to the present embodiment have the same effects as those according to Embodiment 1.

Moreover, in the fuel cell 301 and the fuel cell system according to the present embodiment, the first heat medium supply manifold 8A is formed so as not to penetrate through the entire cell stack body 105 in the stack direction. Therefore, the heat exchange between the heat mediums in the heat medium supply manifolds is prevented. With this, it is possible to supply the heat medium having an appropriate temperature to the end portions E and the remaining portion R of the cell stack 1.

### Embodiment 4

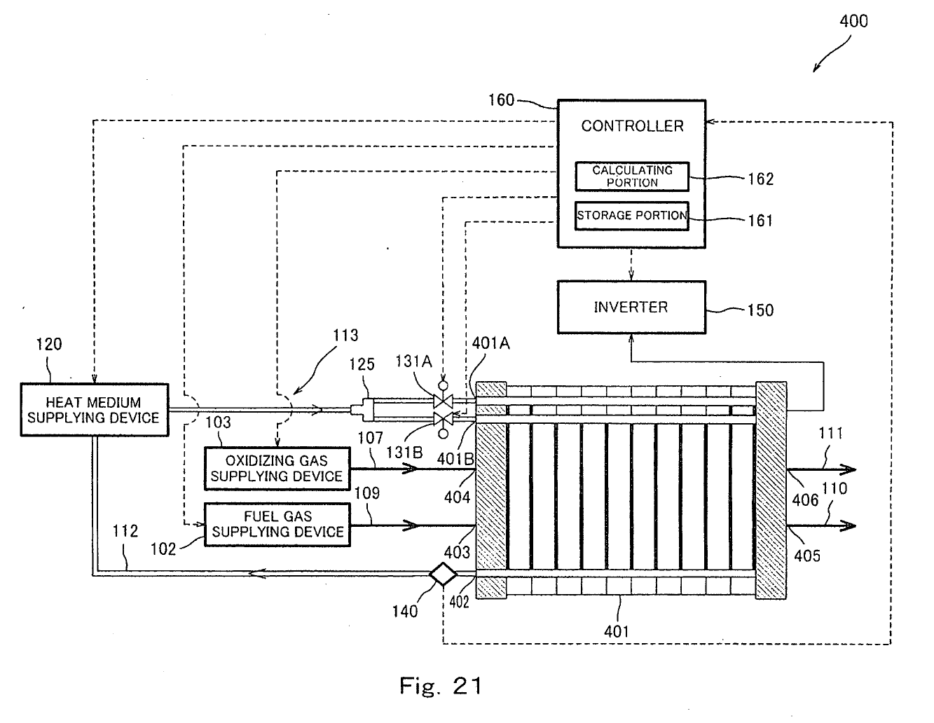

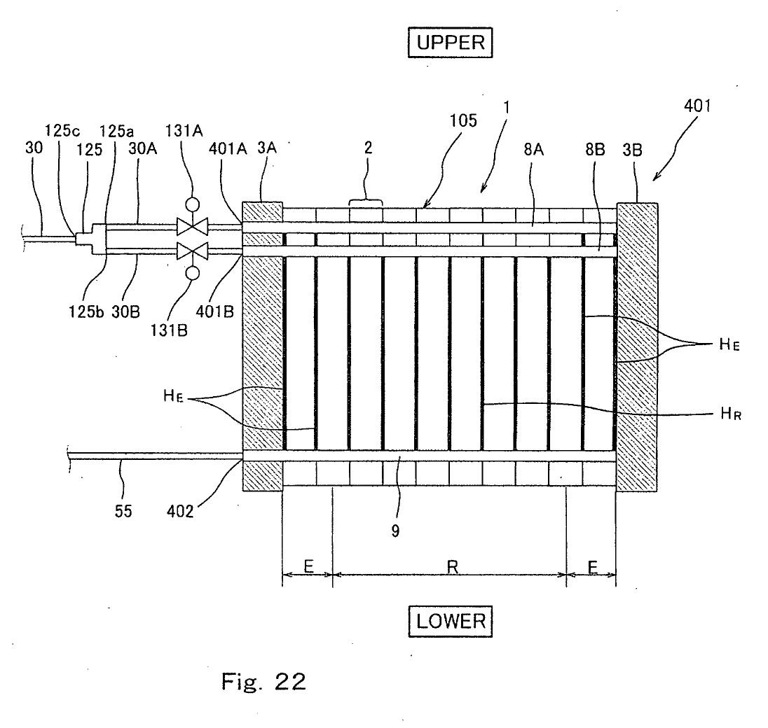

FIG. 21 is a block diagram showing a schematic configuration of the fuel cell system of Embodiment 4 of the present invention. FIG. 22 is a schematic diagram showing the configuration of the fuel cell for use in the fuel cell system of FIG. 21. Hereinafter, the fuel cell system and the fuel cell according to the present embodiment will be explained in reference to FIGS. 21 and 22.

A fuel cell system 400 and a fuel cell 401 according to the present embodiment are configured such that the first on-off valve (first opening/closing device, first flow rate increasing/limiting device) 130A in the fuel cell system and the fuel cell according to Embodiment 1 is replaced with a first flow rate control valve (first flow rate adjuster, first flow rate increasing/limiting device) 131A, and the second on-off valve (second opening/closing device, second flow rate increasing/limiting device) 130B in the fuel cell system and the fuel cell according to Embodiment 1 is replaced with a second flow rate control valve (second flow rate adjuster, second flow rate increasing/limiting device) 131B. In addition, in the present embodiment, the control program (FIG. 9) of the fuel cell system of Embodiment 1 is changed. Other than these, the fuel cell system 400 and the fuel cell 401 according to the present embodiment are configured in the same manner as the fuel cell system and the fuel cell according to Embodiment 1.

Next, operations of the fuel cell system 400 of the present embodiment will be explained in reference to FIG. 9. The control program of the fuel cell system 400 of the present embodiment is designed such that in respective steps of the control program of FIG. 9, the first on-off valve is replaced with the first flow rate control valve, and the second on-off valve is replaced with the second flow rate control valve.

Step S1 of the control program of the fuel cell system 400 of the present embodiment is the same as Step S1 of the control program of FIG. 9.

Next, in Step S2, the controller 160 controls such that each of the first flow rate control valve 131A and the second flow rate control valve 131B opens at a predetermined opening degree. In this case, the opening degree of the first flow rate control valve 131A is larger than that of the second flow rate control valve 131B. With this, the flow rate of the heat medium flowing through the heat transferring portion H_{E} of the end portion E of the cell stack 1 is higher than that of the heat medium flowing through the heat transferring portion H_{R} of the remaining portion R of the cell stack 1. Therefore, since a larger amount of heat medium flows through the heat transferring portion H_{E} of the end portion E of the cell stack 1, it is possible to quickly warm up the remaining portion E of the cell stack 1.

The following Steps S3 to S5 are the same as respective steps of the control program of FIG. 9.

Next, in Step S6, the controller 160 decreases the opening degree of the second flow rate control valve 131A. With this, the flow rate of the heat medium flowing through the heat transferring portion H_{R} of the remaining portion R of the cell stack 1 decreases.

The following Steps S7 to S9 are the same as respective steps of the control program of FIG. 9.

Next, in Step S10, the controller 160 decreases the opening degree of the first flow rate control valve 131A, and increases the opening degree of the second flow rate control valve 131B. With this, the flow rate of the heat medium flowing through the heat transferring portion H_{E} of the end portion E of the cell stack 1 decreases, and the flow rate of the heat medium flowing through the heat transferring portion H_{R} of the remaining portion R of the cell stack 1 increases. In this case, the controller 160 controls such that the opening degree of the second flow rate control valve 131B becomes larger than that of the first flow rate control valve 131A. With this, the flow rate of the heat medium flowing through the heat transferring portion H_{R} of the remaining portion R of the cell stack 1 becomes higher than that of the heat medium flowing through the heat transferring portion H_{E} of the end portion E of the cell stack 1. Then, the fuel cell system 400 shifts to the electric power generating mode to generate the electric power by the fuel cell 401 (Step S11). In this case, by appropriately adjusting the flow rate of the heat medium flowing through the heat transferring portion H_{R} of the remaining portion R of the cell stack 1 and the flow rate of the heat medium flowing through the heat transferring portion H_{E} of the end portion E of the cell stack 1, it is possible to appropriately adjust the degree of cooling of the remaining portion R and the end portion E.

Since the fuel cell system 400 and the fuel cell 401 according to the present embodiment are configured as above, it is possible to quickly warm up the end portions E of the cell stack 1 at the time of the start-up, and appropriately adjust the degree of cooling of the remaining portion R and the end portions E of the cell stack 1 at the time of the electric power generation.

### Embodiment 5

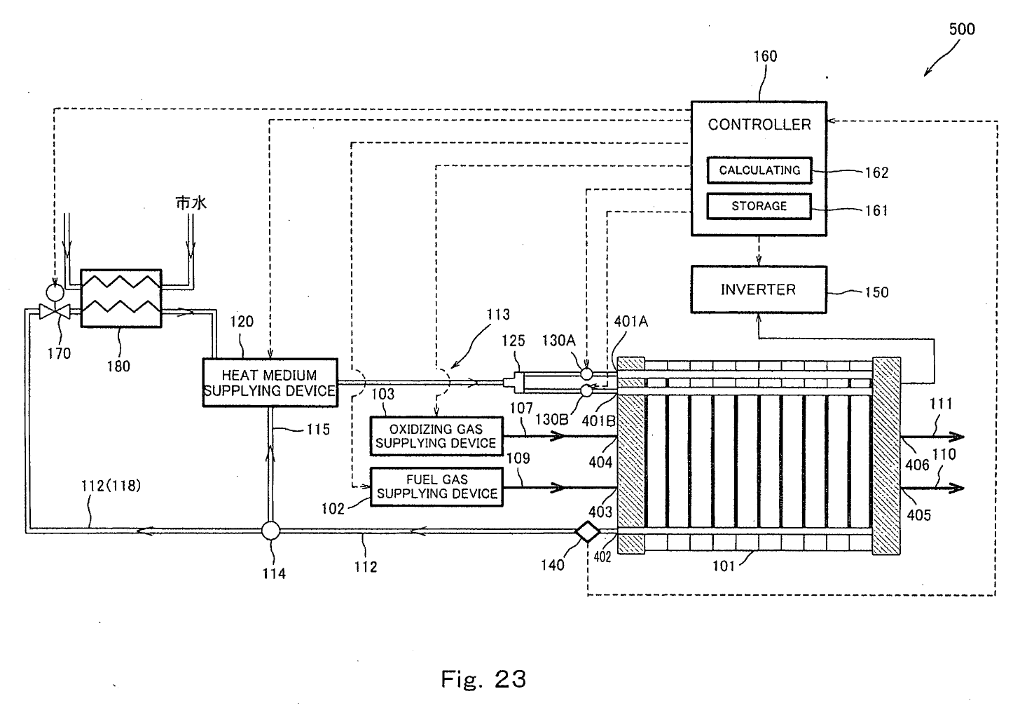

FIG. 23 is a block diagram showing a schematic configuration of the fuel cell system of Embodiment 5 of the present invention. Hereinafter, the fuel cell system of the present embodiment will be explained in reference to FIG. 23.

As shown in FIG. 23, a fuel cell system 500 of the present embodiment is configured such that the configuration of the external heat medium flow passage 112 of the fuel cell system of Embodiment 1 is changed. In addition, the heat medium supplying device 120 of the present embodiment includes a pump (not shown) which causes the heat medium to circulate, and a heater as a temperature adjuster (not shown) for heating. The heater heats the heat medium supplied from the heat medium supplying device 120. Further, in the present embodiment, a heat exchanger 180 as a temperature adjuster for cooling is provided separately from the heat medium supplying device 120. Other than these, the fuel cell system 500 of the present embodiment is the same as the fuel cell system of Embodiment 1.

Next, the configuration of the external heat medium flow passage 112 will be explained in detail.

In the fuel cell system 500 of the present embodiment, a flow rate control valve (flow rate adjuster) 170 and the heat exchanger 180 are disposed on portions (of a bypassed portion 118) of the external heat medium flow passage 112 in order. The flow rate control valve 170 may be disposed downstream of the portion of the external heat medium flow passage 112 on which portion the heat exchanger 180 is disposed. The flow rate control valve 170 adjusts the flow rate of the heat medium which has been discharged from the heat medium discharge manifold 9, has flowed through the external heat medium flow passage 112, and will flow to the heat exchanger 180 (therefore, a ratio between the flow rate of the heat medium flowing through the heat exchanger 180 and the flow rate of the heat medium flowing through a bypass passage 115 is adjusted). Inside the heat exchanger 180, a passage through which the heat medium flows and a passage through which city water flows are formed. In the electric power generating mode, the temperature of the city water flowing through the heat exchanger 180 is lower than that of the heat medium flowing through the heat exchanger 180. With this, the heat is transferred from the heat medium to the city water, and therefore, the heat medium is cooled down. This cooled heat medium flows through the heat medium supplying device 120. In a case where it is possible to cause the city water and water (hot water for example), which has a higher temperature than the heat medium flowing through the heat exchanger 180, to flow through the above passage through which the city water flows, while switching between the city water and the hot water, the heat exchanger 180 functions as a heating-cooling device for heating and cooling the heat medium.

Moreover, a branched portion 114 is formed on the external heat medium flow passage 112. An upstream end of the bypass passage 115 is connected to the branched portion 114. A downstream end of the bypass passage 115 is connected to the heat medium supplying device 120. The bypass passage 115 bypasses the heat exchanger 180, so that the heat medium is directly supplied to the heat medium supplying device 120. With this, the heat medium having flowed through (the bypassed portion 118 of) the external heat medium flow passage 112 to the heat medium supplying device 120 and the heat medium having flowed through the bypass passage 115 to the heat medium supplying device 120 are mixed with each other in the heat medium supplying device 120. In this case, the controller 160 controls the opening degree of the flow rate control valve 170 to change a mixing ratio therebetween. With this, the temperature of the heat medium supplied from the heat medium supplying device 120 can be suitably changed.

Next, operations for adjusting the temperature of the heat medium and operations for supplying the heat medium in the start-up mode and the electric power generating mode of the fuel cell system 500 of the present embodiment will be explained. The control program of the present embodiment is basically the same as the control program of the fuel cell system of Embodiment 1, so that only differences therebetween will be explained. Note that these operations are realized by the controller 160.

In the start-up mode, the controller 160 opens the first on-off valve 130A and the second on-off valve 130B (see Step S2 of FIG. 9) to supply the heat medium to the end portions E and the remaining portion R of the cell stack 1. Then, the controller 160 closes the second on-off valve 130B (see Step S6 of FIG. 9) to supply the heat medium to the end portions E of the cell stack 1. In this case, the controller 160 closes the flow rate control valve 170, and causes the heater, not shown, to heat the heat medium at a predetermined temperature (herein, 60° C.). With this, the cell stack 1 can be increased in temperature.

Meanwhile, in the electric power generating mode, the controller 160 closes the first on-off valve 130A and opens the second on-off valve 130B (see Step S10 of FIG. 9) to supply the heat medium only to the remaining portion R of the cell stack 1. With this, the remaining portion R is cooled down by the heat medium, and the heat medium recovers the reaction heat generated at the reacting portion P of the remaining portion R to increase in temperature. Further, the controller 160 opens the flow rate control valve 170 to supply to the heat medium supplying device 120 the heat medium which has been subjected to the heat exchange (cooling) by the heat exchanger 180. Thus, the heat medium having been cooled down by the heat exchanger 180 and the heat medium having passed through the bypass passage 115 and still having a high temperature are mixed with each other in the heat medium supplying device 120. Here, the controller 160 adjusts the opening degree of the flow rate control valve 170 such that the temperature of the heat medium mixed in the heat medium supplying device 120 becomes the above predetermined temperature (60° C.). Note that the heater included in the heat medium supplying device 120 stops in the electric power generating mode. With this, the heat medium having the predetermined temperature is supplied from the heat medium supplying device 120 to the remaining portion R of the cell stack 1, and therefore, the cell stack 1 is appropriately cooled down.

As above, the fuel cell system 500 of the present embodiment can obtain the same effects as the fuel cell system of Embodiment 1.

In the foregoing, the heat medium having a constant temperature (60° C.) is supplied to the cell stack 1. However, the heat medium supplied in the start-up mode and the heat medium supplied in the electric power generating mode may be different in temperature from each other. For example, the heat medium supplied in the start-up mode may be higher in temperature than the heat medium supplied in the electric power generating mode. In this case, it is possible to quickly increase the temperature of the cell stack 1.

In the fuel cell system 500 of the present embodiment, the first temperature adjuster (not shown) may be disposed on the first heat medium supply pipe 30A (see FIG. 2) extending between the T-shaped tube joint 125 and the first heat medium entrance 401A, and the second temperature adjuster (not shown) may be disposed on the second heat medium supply pipe 30B (see FIG. 2) extending between the T-shaped tube joint 125 and the second heat medium entrance 401B. With this, in a case where the heat medium supplied from the heat medium supplying device 120 flows through the first heat medium supply pipe 30A, the temperature of the heat medium is readjusted by the first temperature adjuster, and in a case where the heat medium supplied from the heat medium supplying device 120 flows through the second heat medium supply pipe 30B, the temperature of the heat medium is readjusted by the second temperature adjuster. Therefore, in the start-up mode, in a case where the heat medium is supplied through the first heat medium supply manifold 8A to the heat transferring portion H_{E} of the end portion E of the cell stack 1, and the heat medium is supplied through the second heat medium supply manifold 8B to the heat transferring portion H_{R} of the remaining portion R of the cell stack 1, the heat medium supplied to the heat transferring portion H_{E} of the end portion E and the heat medium supplied to the heat transferring portion H_{R} of the remaining portion R can be made different in temperature from each other. Especially, by supplying the high-temperature heat medium to the heat transferring portion H_{E} of the end portion E which releases much heat from the end plates 3A and 3B, it is possible to quickly increase the temperature of the end portion E of the cell stack 1.

Further, in the case of readjusting the temperature of the heat medium supplied to any one of the end portion E and the remaining portion R of the cell stack 1, a temperature adjuster (not shown) may be disposed on any one of the first heat medium supply pipe 30A extending between the T-shaped tube joint 125 and the first heat medium entrance 401A and the second heat medium supply pipe 30B extending between the T-shaped tube joint 125 and the second heat medium entrance 401B.

### Embodiment 6

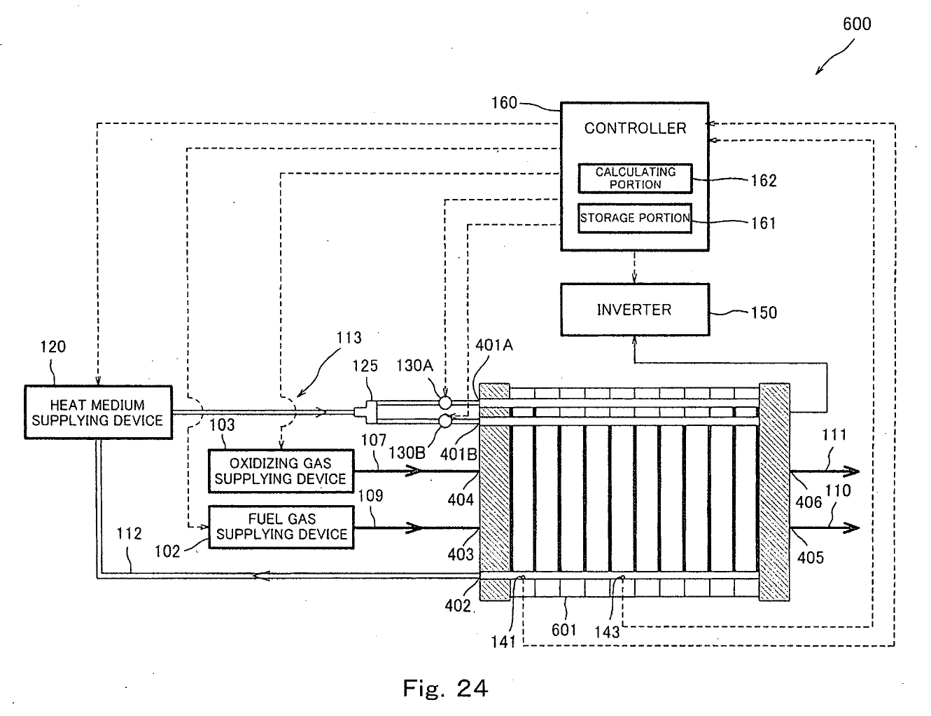

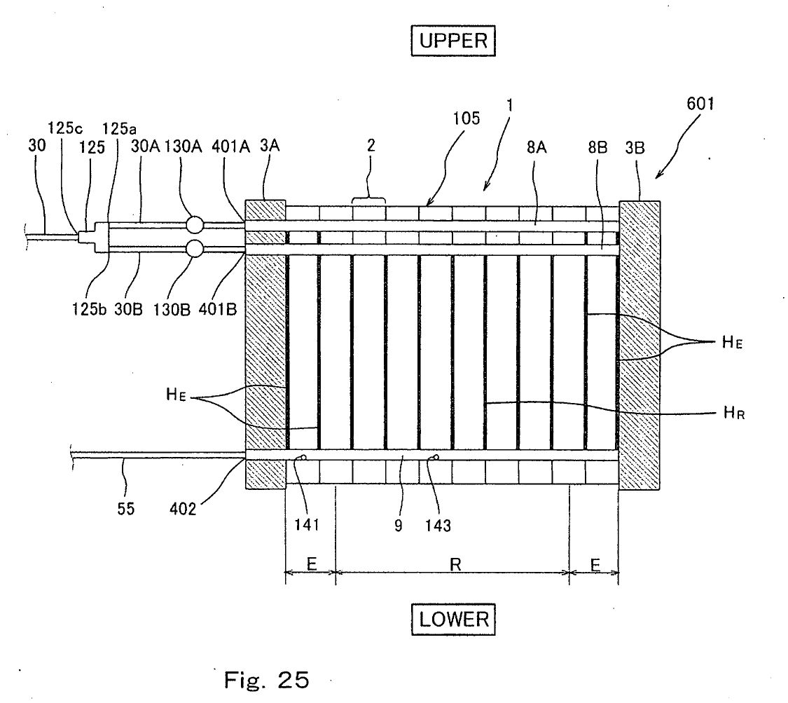

FIG. 24 is a block diagram showing a schematic configuration of the fuel cell system of Embodiment 6 of the present invention. FIG. 25 is a schematic diagram showing the configuration of the fuel cell for use in the fuel cell system of FIG. 24. Hereinafter, the fuel cell system and the fuel cell according to the present embodiment will be explained in reference to FIGS. 24 and 25.

A fuel cell system 600 and a fuel cell 601 according to the present embodiment are configured such that in the fuel cell system (FIG. 1) and the fuel cell (FIG. 2) according to Embodiment 1, the position where the temperature detector for detecting the temperature of the heat medium is disposed is changed.

In Embodiment 1, the temperature detector for detecting the temperature of the heat medium is disposed on the external heat medium flow passage 112 in the vicinity of the exit of the heat medium discharge manifold 9. In the present embodiment, as shown in FIGS. 24 and 25, temperature detectors 141 and 143 for detecting the temperature of the heat medium are disposed inside the heat medium discharge manifold 9. Specifically, the end portion temperature detector 141 is disposed at the end portion E of the cell stack 1 and in the heat medium discharge manifold 9 in the vicinity of the heat medium exit 402. In addition, the remaining portion temperature detector 143 is disposed in the heat medium discharge manifold 9 of the remaining portion R of the cell stack 1. The remaining portion temperature detector 143 is disposed substantially at the center of the remaining portion R of the cell stack 1. Of course, the remaining portion temperature detector 143 may be disposed at a position other than the center of the heat medium discharge manifold 9 of the remaining portion R of the cell stack 1. In this case, the temperature detected by the remaining portion temperature detector disposed at the position other than the center of the heat medium discharge manifold 9 may be corrected as the temperature detected at the center of the heat medium discharge manifold 9, or may not be corrected in a case where its temperature error is tolerable. Moreover, a plurality of the remaining portion temperature detectors 143 may be disposed at the heat medium discharge manifold 9 of the remaining portion R of the cell stack 1, and an average value of the temperatures detected by the remaining portion temperature detectors 143 may be used. Each of the end portion temperature detector 141 and the remaining portion temperature detector 143 detects the temperature of the heat medium flowing inside the heat medium discharge manifold 9. Moreover, since the end portion temperature detector 141 and the remaining portion temperature detector 143 are formed separately, the temperature at the end portion E and the temperature at (the center of) the remaining portion R can be detected separately. As shown in FIG. 24, the temperature detected by the end portion temperature detector 141 and the temperature detected by the remaining portion temperature detector 143 are input to the controller 160. Other than these, the fuel cell system 600 and the fuel cell 601 according to the present embodiment are the same in configuration as the fuel cell system and the fuel cell according to Embodiment 1.

The fuel cell system 600 and the fuel cell 601 according to the present embodiment can obtain the same effects as those according to Embodiment 1.

Moreover, in the fuel cell system 600 and the fuel cell 601 according to the present embodiment, it is possible to individually detect the temperature of the heat medium at the end portion E of the cell stack 1 and the temperature of the heat medium at the remaining portion R of the cell stack 1, and therefore, it is possible to accurately control the temperature of the end portion E and the temperature of the remaining portion R by controlling the temperature of the heat medium supplied to the end portion E and the temperature of the heat medium supplied to the remaining portion R.

Further, the configuration in which the end portion temperature detector and the remaining portion temperature detector are disposed inside the heat medium discharge manifold as in the present embodiment can be applied to the fuel cell system (FIG. 10) and the fuel cell (FIG. 11) according to Embodiment 2. Specifically, the end portion temperature detector is disposed in the vicinity of the exit of the first heat medium discharge manifold 9A, and the remaining portion temperature detector is disposed at the center of the second heat medium discharge manifold 9B. As with the foregoing, the remaining portion temperature detector may be disposed at a position other than the center of the second heat medium discharge manifold 9B. In this case, the temperature detected by the remaining portion temperature detector disposed at the position other than the center of the second heat medium discharge manifold 9B may be corrected as the temperature detected at the center of the second heat medium discharge manifold 9B, or may not be corrected in a case where its temperature error is tolerable. Moreover, a plurality of the remaining portion temperature detectors may be disposed at the second heat medium discharge manifold 9B, and an average value of the temperatures detected by the remaining portion temperature detectors may be used.

In the fuel cell system 600 and the fuel cell 601 according to the present embodiment, the end portion temperature detector 141 and the remaining portion temperature detector 143 are disposed inside the heat medium discharge manifold 9. However, each of the end portion temperature detector 141 and the remaining portion temperature detector 143 may be disposed not inside the heat medium discharge manifold 9 but at the cell 2. Specifically, the end portion temperature detector 141 is disposed at the cell 2 of the end portion E of the cell stack 1, and the remaining portion temperature detector 143 is disposed at the cell 2 of the remaining portion R of the cell stack 1. Then, each of the temperature of the cell 2 detected by the temperature detector 141 and the temperature of the cell 2 detected by the temperature detector 143 may be suitably corrected to be converted to the temperature of the heat medium flowing through the heat medium discharge manifold 9. To be specific, the temperature of the heat medium flowing through the heat medium discharge manifold 9 may be directly measured, or may be indirectly measured by detecting and correcting the temperature of the cell 2.

### Embodiment 7

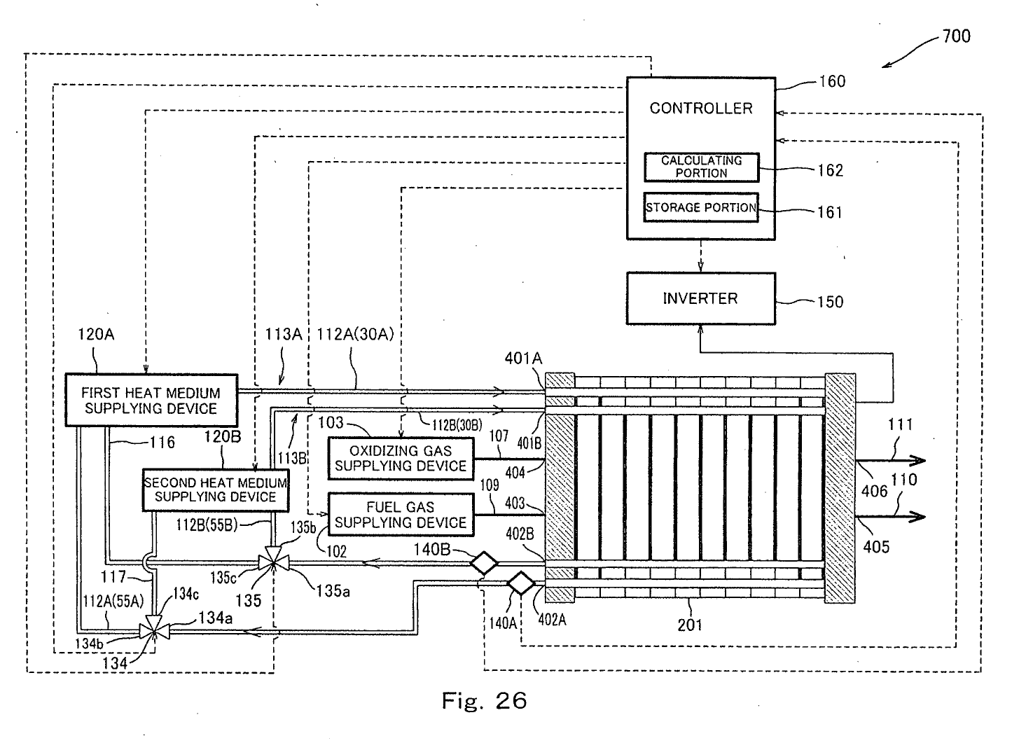

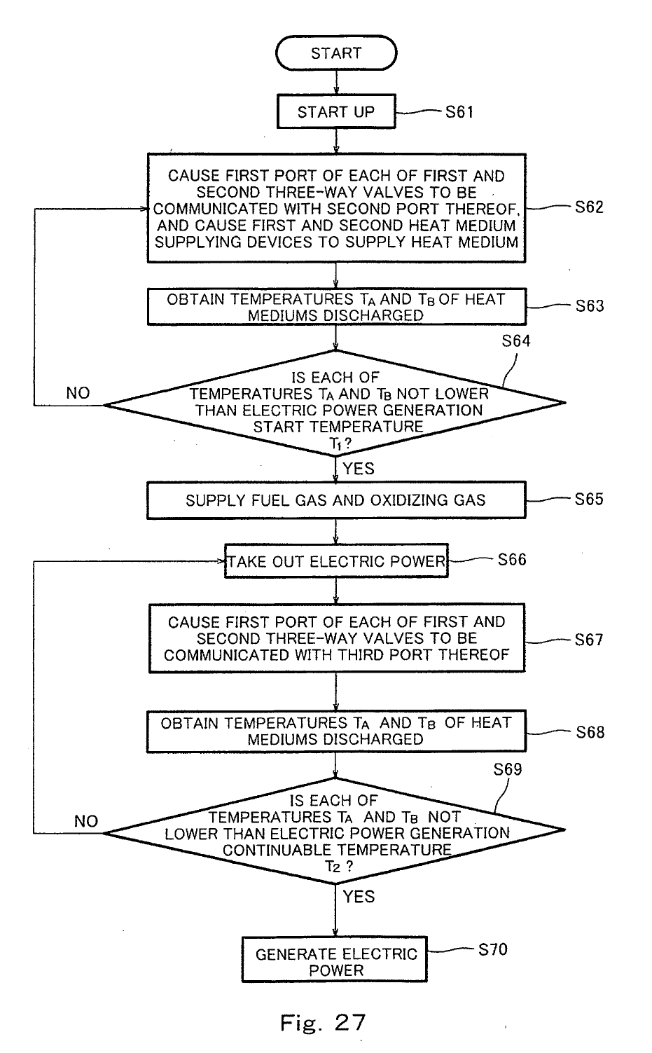

FIG. 26 is a block diagram showing a schematic configuration of the fuel cell system of Embodiment 7 of the present invention. FIG. 27 is a flow chart showing a control program for controlling the fuel cell system of FIG. 26. Hereinafter, the fuel cell system of the present embodiment will be explained in reference to FIGS. 26 and 27.

A fuel cell system 700 of the present embodiment is configured such that the configurations of the first and second external heat medium flow passage 112A and 112B in the fuel cell system of Embodiment 2 are changed (Note that the fuel cell used in the fuel cell system 700 is the same as the fuel cell 201 shown in FIG. 11.).

Specifically, as shown in FIG. 26, a first three-way valve (first flow passage selector) 134 is disposed on a portion of the first external heat medium flow passage 112A. The first three-way valve 134 includes a first port 134a, a second port 134c, and a third port 134b. A part of the first external heat medium flow passage 112A extending toward the first heat medium exit 402A is connected to the first port 134a. A downstream end of a part of the first external heat medium flow passage 112A extending toward the first heat medium supplying device 120A is connected to the second port 134c. An upstream end of a third external heat medium flow passage 117 is connected to the third port 134b. A downstream end of the third external heat medium flow passage 117 is connected to the second heat medium supplying device 120B. A destination with which the first port 134a is communicated is switched by the controller 160 between the second port 134c and the third port 134b. With this, a destination to which the heat medium having been discharged from the first heat medium discharge manifold 9A flows is switched between the first heat medium supplying device 120A and the second heat medium supplying device 120B.

Moreover, a second three-way valve (second flow passage selector) 135 is disposed on a portion of the second external heat medium flow passage 112B. The second three-way valve 135 includes a first port 135a, a second port 135b, and a third port 135c. A part of the second external heat medium flow passage 112B extending toward the second heat medium exit 402B is connected to the first port 135a. A downstream end of a part of the second external heat medium flow passage 112B extending toward the second heat medium supplying device 120B is connected to the second port 135b. An upstream end of a fourth external heat medium flow passage 116 is connected to the third port 135c. A downstream end of the fourth external heat medium flow passage 116 is connected to the first heat medium supplying device 120A. A destination with which the first port 135a is communicated is switched by the controller 160 between the second port 135b and the third port 135c. With this, a destination to which the heat medium having been discharged from the second heat medium discharge manifold 9B is switched between the second heat medium supplying device 120B and the first heat medium supplying device 120A.

Next, characteristic operations of the fuel cell system 700 of the present embodiment will be explained.

In an initial state, the first port 134a of the first three-way valve 134 is communicated with the second port 134c, and the first port 135a of the second three-way valve 135 is communicated with the second port 135b (Step S61). Other than this, Steps S61 to S66 are the same as Steps S21 to S26 of the control program (FIG. 16) for controlling the fuel cell system of Embodiment 2. Therefore, hereinafter, Step S67 and the following steps will be explained.

After the controller 160 has started taking out the electric power in Step S66, it changes the destination with which the first port 134a of the first three-way valve 134 is communicated, from the second port 134c to the third port 134b, and changes the destination with which the first port 135a of the second three-way valve 135 is communicated, from the second port 135b to the third port 135c (Step S67). With this, the destination to which the heat medium having been discharged from the first heat medium discharge manifold 9A flows is changed from the first heat medium supplying device 120A to the second heat medium supplying device 120B, and the destination to which the heat medium having been discharged from the second heat medium discharge manifold 9B flows is changed from the second heat medium supplying device 120B to the first heat medium supplying device 120A. Here, the heat medium having been discharged from the second heat medium discharge manifold 9B flows through the heat transferring portion H_{R} of the remaining portion R of the cell stack 1 to recover the reaction heat of the electric power generating reaction at the reacting portion P, thereby increasing in temperature. Therefore, since the heat medium having been increased in temperature is supplied to the first heat medium supplying device 120A, the consumption energy of the temperature adjuster (not shown) which is included in the first heat medium supplying device 120A and heats the heat medium becomes small.

The following Steps S68 to S70 are the same as the corresponding steps (Steps S27 to S29) of the control program of FIG. 16.

The fuel cell system 700 of the present embodiment can obtain the same effects as the fuel cell system of Embodiment 2.

Moreover, in the fuel cell system 700 of the present embodiment, the heat medium which has flowed through the heat transferring portion H_{R} of the remaining portion R of the cell stack 1 and has recovered the heat to increase in temperature is supplied to the first heat medium supplying device 120A, and flows through the end portion E of the cell stack 1. Therefore, it is possible to save the energy for increasing the temperature of the heat medium in the first heat medium supplying device 120A.

The foregoing has explained a case where in the fuel cell of each of the above embodiments, two heat transferring portions H_{E} are formed at the end portion E of the cell stack 1. The number of heat transferring portions H_{E} of the end portion E is suitably determined in accordance with, for example, the number of cells of the cell stack 1.

Moreover, the foregoing has explained a case where in the fuel cell of each of the above embodiments, the heat transferring portion H_{E} (heat medium channel) is formed on the main surface of the separator which surface contacts the end plate 3A or 3B. However, the present invention can be applied to a case where the heat transferring portion H_{E} (heat medium channel) is not formed on the main surface of the separator which surface contacts the end plate 3A or 3B. In this case, the number of heat transferring portions H_{E} of the end portion E is obtained by subtracting 1 from the number of heat transferring portions H_{E} which number is determined as above. In the above embodiments, two heat transferring portions H_{E} are formed at the end portion E of the cell stack 1. Therefore, in a case where the heat transferring portion H_{E} (heat medium channel) is not formed on the main surface of the separator which surface contacts the end plate 3A or 3B, the number of heat transferring portions H_{E} of the end portion E is 1.

From the foregoing explanation, many modifications and other embodiments of the present invention are obvious to one skilled in the art. Therefore, the foregoing explanation should be interpreted only as an example, and is provided for the purpose of teaching the best mode for carrying out the present invention to one skilled in the art. The structures and/or functional details may be substantially modified within the spirit of the present invention.

### INDUSTRIAL APPLICABILITY

The fuel cell and the fuel cell system according to the present invention is useful as a fuel cell capable of controlling the temperature of the cell stack at the time of both the start-up and the electric power generation, and a fuel cell system using such fuel cell.

1. A fuel cell comprising:
a stack formed such that one or more reacting portions which generate electric power and heat by a reaction of a reactant gas and one or more heat transferring portions which exchange heat with the reacting portions by flow of a heat medium are arranged adjacent to each other in a stack direction of cells by stacking the cells;
a first heat medium supply manifold through which the heat medium is supplied to the heat transferring portions formed at both end portions of the stack in the stack direction;
a second heat medium supply manifold through which the heat medium is supplied to the heat transferring portions formed at a remaining portion of the stack which portion is a portion other than the end portions of the stack; and
a heat medium discharge manifold through which the heat medium is discharged from the heat transferring portions.

2. The fuel cell according to claim 1, wherein the first heat medium supply manifold, the second heat medium supply manifold, and the heat medium discharge manifold are formed inside the stack so as to extend in the stack direction of the cells.

3. The fuel cell according to claim 2, wherein the first heat medium supply manifold is formed over an entire length of the stack.

4. The fuel cell according to claim 2, wherein the first heat medium supply manifold is formed only at each of the both end portions.

5. The fuel cell according to claim 1, further comprising:
a first flow rate increasing/limiting device configured to increase and limit the flow of the heat medium from an outside to the first heat medium supply manifold by increasing and decreasing an opening degree thereof; and
a second flow rate increasing/limiting device configured to increase and limit the flow of the heat medium from the outside to the second heat medium supply manifold by increasing and decreasing an opening degree thereof.

6. The fuel cell according to claim 1, wherein:
the heat medium discharge manifold includes at least a first heat medium discharge sub-manifold and a second heat medium discharge sub-manifold;
the heat medium in the heat transferring portions of the both end portions is discharged through the first heat medium discharge sub-manifold; and
the heat medium in the heat transferring portions of the remaining portion is discharged through the second heat medium discharge sub-manifold.

7. A fuel cell system comprising:
the fuel cell according to claim 1;
a reactant gas supplying device configured to supply the reactant gas to the fuel cell;
a heat medium supplying device configured to supply the heat medium to the first heat medium supply manifold and the second heat medium supply manifold; and
a controller.

8. A fuel cell system comprising:
the fuel cell according to claim 5;
a reactant gas supplying device configured to supply the reactant gas to the fuel cell;
a heat medium supplying device configured to supply the heat medium through the first flow rate increasing/limiting device to the first heat medium supply manifold and through the second flow rate increasing/limiting device to the second heat medium supply manifold;
a temperature detector configured to directly or indirectly detect the temperature of the heat medium flowing through the heat medium discharge manifold or the temperature of the heat medium discharged from the heat medium discharge manifold; and
a controller configured to control the opening degree of the first flow rate increasing/limiting device and the opening degree of the second flow rate increasing/limiting device.

9. The fuel cell system according to claim 7 comprising:
an external heat medium flow passage through which the heat medium discharged from the heat medium discharge manifold returns to the heat medium supplying device;
a bypass passage connecting a portion of the external heat medium flow passage to the heat medium supplying device;
a heat exchanger disposed on a portion (hereinafter referred to as “bypassed portion”) of the external heat medium flow passage which portion is bypassed by the bypass passage, and configured to exchange heat with the heat medium flowing through the bypassed portion; and
a flow rate adjuster disposed on the bypassed portion of the external heat medium flow passage and configured to be controlled by the controller so as to adjust the flow rate of the heat medium flowing through the bypassed portion.

10. The fuel cell system according to claim 8, wherein the controller is configured to cause a flow rate controller to change a mixing ratio between the heat medium having flowed through the bypassed portion of the external heat medium flow passage and the heat medium having flowed through the bypass passage of the external heat medium flow passage, which are mixed in the heat medium supplying device, to control the temperature of the heat medium supplied from the heat medium supplying device.

11. The fuel cell system according to claim 9, wherein the controller is configured to control the opening degree of the first flow rate increasing/limiting device and the opening degree of the second flow rate increasing/limiting device based on the temperature of the heat medium detected by a temperature detector.

12. The fuel cell system according to claim 10, further comprising an electric power circuit portion configured to take out the electric power from the fuel cell, wherein:
the controller causes the fuel cell to carry out an electric power generating mode in which the fuel cell generates the electric power and supplies the electric power to an external load and a start-up mode in which the fuel cell shifts from a stop state to the electric power generating mode;
while the temperature of the heat medium detected by the temperature detector is lower than an electric power generation start temperature T₁, in the start-up mode, the controller causes the first flow rate increasing/limiting device to increase the opening degree to supply the heat medium without limit through the first heat medium supply manifold to the heat transferring portions of the end portions, and causes the second flow rate increasing/limiting device to increase the opening degree to supply the heat medium without limit through the second heat medium supply manifold to the heat transferring portions of the remaining portion;
when the temperature of the heat medium detected by the temperature detector is the electric power generation start temperature T₁ or higher, the controller maintains the opening degree of the first flow rate increasing/limiting device and causes the second flow rate increasing/limiting device to decrease the opening degree to cause the reactant gas supplying device to supply the reactant gas to the fuel cell and cause the electric power circuit portion to take out the electric power; and
when the temperature of the heat medium detected by the temperature detector is an electric power generation continuable temperature T₂ or higher which is higher than the electric power generation start temperature T₁, the controller causes the first flow rate increasing/limiting device to decrease the opening degree to limit the flow of the heat medium to the heat transferring portions of the end portions and causes the second flow rate increasing/limiting device to increase the opening degree to supply the heat medium without limit to the heat transferring portions of the remaining portion, to cause the fuel cell system to shift to the electric power generating mode.

13. The fuel cell according to claim 11, wherein:
the first flow rate increasing/limiting device is a first opening/closing device configured to open to allow the flow of the heat medium to the first heat medium supply manifold and close to inhibit the flow of the heat medium to the first heat medium supply manifold, and the second flow rate increasing/limiting device is a second opening/closing device configured to open to allow the flow of the heat medium to the second heat medium supply manifold and close to inhibit the flow of the heat medium to the second heat medium supply manifold; and
increasing the opening degrees of the first and second flow rate increasing/limiting devices to supply the heat medium without limit is opening the first and second opening/closing devices to supply the heat medium, and decreasing the opening degrees of the first and second flow rate increasing/limiting devices to limit the flow of the heat medium is closing the first and second opening/closing devices to stop the flow of the heat medium.

14. The fuel cell according to claim 12, wherein:
the first flow rate increasing/limiting device is a first flow rate adjuster configured to adjust the flow rate of the heat medium flowing to the first heat medium supply manifold, and the second flow rate increasing/limiting device is a second flow rate adjuster configured to adjust the flow rate of the heat medium flowing to the second heat medium supply manifold; and
increasing the opening degrees of the first and second flow rate increasing/limiting devices to supply the heat medium without limit is increasing the opening degrees of the first and second flow rate adjusters to increase the flow rate of the heat medium, and decreasing the opening degrees of the first and second flow rate increasing/limiting devices to limit the flow of the heat medium is decreasing the opening degrees of the first and second flow rate adjusters to decrease the flow rate of the heat medium.

15. A fuel cell system comprising:
the fuel cell according to claim 6;
a reactant gas supplying device configured to supply the reactant gas to the fuel cell;
a first heat medium supplying device configured to supply the heat medium to the first heat medium supply manifold;
a second heat medium supplying device configured to supply the heat medium to the second heat medium supply manifold;
a first temperature detector configured to directly or indirectly detect the temperature of the heat medium flowing through the first heat medium discharge sub-manifold or the temperature of the heat medium discharged from the first heat medium discharge sub-manifold;
a second temperature detector configured to directly or indirectly detect the temperature of the heat medium flowing through the second heat medium discharge sub-manifold or the temperature of the heat medium discharged from the second heat medium discharge sub-manifold; and
a controller configured to control the first heat medium supplying device and the second heat medium supplying device.

16. The fuel cell system according to claim 15, further comprising an electric power circuit portion configured to take out the electric power from the fuel cell, wherein:
the controller causes the fuel cell to carry out an electric power generating mode in which the fuel cell generates the electric power and supplies the electric power to an external load and a start-up mode in which the fuel cell shifts from a stop state to the electric power generating mode;
while one of the temperature of the heat medium detected by the first temperature detector and the temperature of the heat medium detected by the second temperature detector is lower than an electric power generation start temperature T₁ in the start-up mode, the controller causes the first heat medium supplying device to supply the heat medium through the first heat medium supply manifold to the heat transferring portions of the end portions, and causes the second heat medium supplying device to supply the heat medium through the second heat medium supply manifold to the heat transferring portions of the remaining portion;
when each of the temperature of the heat medium detected by the first temperature detector and the temperature of the heat medium detected by the second temperature detector is the electric power generation start temperature T₁ or higher, the controller causes the reactant gas supplying device to supply the reactant gas to the fuel cell and causes the electric power circuit portion to take out the electric power; and
when each of the temperature of the heat medium detected by the first temperature detector and the temperature of the heat medium detected by the second temperature detector is an electric power generation continuable temperature T₂ or higher which is higher than the electric power generation start temperature T₁, the controller causes the fuel cell system to shift to the electric power generating mode.

17. The fuel cell system according to claim 15, wherein the controller is configured to control an amount of heat medium supplied from the first heat medium supplying device and an amount of heat medium supplied from the second heat medium supplying device based on the temperature of the heat medium detected by the first temperature detector and the temperature of the heat medium detected by the second temperature detector.

18. The fuel cell system according to claim 15, further comprising an electric power circuit portion configured to take out the electric power from the fuel cell, wherein:
the controller causes the fuel cell to carry out an electric power generating mode in which the fuel cell generates the electric power and supplies the electric power to an external load and a start-up mode in which the fuel cell shifts from a stop state to the electric power generating mode;
while one of the temperature of the heat medium detected by the first temperature detector and the temperature of the heat medium detected by the second temperature detector is lower than an electric power generation start temperature T₁ in the start-up mode, the controller causes the first heat medium supplying device to supply the heat medium through the first heat medium supply manifold to the heat transferring portions of the end portions, and causes the second heat medium supplying device to supply the heat medium through the second heat medium supply manifold to the heat transferring portions of the remaining portion;
when each of the temperature of the heat medium detected by the first temperature detector and the temperature of the heat medium detected by the second temperature detector is the electric power generation start temperature T₁ or higher, the controller causes the first heat medium supplying device to continue to supply the heat medium to the heat transferring portions of the end portions, causes the second heat medium supplying device to limit the amount of heat medium supplied to the heat transferring portions of the remaining portion, causes the reactant gas supplying device to supply the reactant gas to the fuel cell, and causes the electric power circuit portion to take out the electric power; and
when each of the temperature of the heat medium detected by the first temperature detector and the temperature of the heat medium detected by the second temperature detector is an electric power generation continuable temperature T₂ or higher which is higher than the electric power generation start temperature T₁, the controller causes the first heat medium supplying device to limit the amount of heat medium supplied through the first heat medium supply manifold to the heat transferring portions of the end portions, and causes the second heat medium supplying device to cancel limitation of the amount of heat medium supplied through the second heat medium supply manifold to the heat transferring portions of the remaining portion, to cause the fuel cell system to shift to the electric power generating mode.

19. The fuel cell system according to claim 18, wherein the controller stops supplying the heat medium to limit the amount of heat medium supplied.

20. The fuel cell system according to claim 15, wherein the temperature of the heat medium supplied from the first heat medium supplying device is higher than the temperature of the heat medium supplied from the second heat medium supplying device.

21. The fuel cell system according to claim 16, further comprising:
a first external heat medium flow passage through which the heat medium discharged from the first heat medium discharge sub-manifold returns to the first heat medium supplying device;
a second external heat medium flow passage through which the heat medium discharged from the second heat medium discharge sub-manifold returns to the second heat medium supplying device;
a third external heat medium flow passage;
a first flow passage selector disposed on a portion of the first external heat medium flow passage so as to be connected to the second heat medium supplying device by the third external heat medium flow passage, and configured to switch a destination to which the heat medium discharged from the first heat medium discharge sub-manifold flows, between the first heat medium supplying device and the second heat medium supplying device;
a fourth external heat medium flow passage; and
a second flow passage selector disposed on a portion of the second external heat medium flow passage so as to be connected to the first heat medium supplying device by the fourth external heat medium flow passage, and configured to switch a destination to which the heat medium discharged from the second heat medium discharge sub-manifold flows, between the second heat medium supplying device and the first heat medium supplying device, wherein
after the controller causes the reactant gas supplying device to supply the reactant gas to the fuel cell and causes the electric power circuit portion to take out the electric power in the start-up mode, the controller causes the first flow passage selector to supply the heat medium, having been discharged from the first heat medium discharge manifold, through the third external heat medium flow passage to the second heat medium supplying device to cause the second heat medium supplying device to continue to supply the heat medium through the second heat medium supply manifold to the heat transferring portions of the remaining portion, and causes the second flow passage selector to supply the heat medium, having been discharged from the second heat medium discharge manifold, through the fourth external heat medium flow passage to the first heat medium supplying device to cause the first heat medium supplying device to continue to supply the heat medium through the first heat medium supply manifold to the heat transferring portions of the end portions.
